(19) United States
(12) Patent Application Publication
(10) Pub. No.: US 2024/0013546 A1
(43) Pub. Date: Jan. 11, 2024

(54) INFORMATION PROVIDING METHOD, INFORMATION PROVIDING SYSTEM, AND NON-TRANSITORY COMPUTER-READABLE RECORDING MEDIUM

(71) Applicant: Panasonic Holdings Corporation, Osaka (JP)

(72) Inventors: YURI NISHIKAWA, Kanagawa (JP); JUN OZAWA, Nara (JP)

(21) Appl. No.: 18/474,311

(22) Filed: Sep. 26, 2023

Related U.S. Application Data
(63) Continuation of application No. PCT/JP2022/011252, filed on Mar. 14, 2022.

(30) Foreign Application Priority Data
Apr. 13, 2021 (JP) 2021-068044

(51) Int. Cl. G06V 20/52; G06V 40/10; G06T 7/50; H04N 7/18; G06F 40/42; G06K 7/10

(52) U.S. Cl. CPC G06V 20/52; G06V 40/10; G06T 7/50; H04N 7/181; G06F 40/42; G06K 7/10366; G06V 2201/08

(57) ABSTRACT

This information providing method includes causing a computer to acquire first information concerning a user (person) present in a first area of an escalator, acquire second information concerning the user present in a second area of the escalator, acquire third information concerning a vehicle present on the escalator that is relevant to at least one of the first information or the second information, determine a change in state of the vehicle on the basis of the third information, and output notification information indicative of notification contents decided on the basis of the determined change in state of the vehicle.

### BACKGROUND

### 1. Technical Field

The present disclosure relates to an information providing method for providing information to a user of an escalator, and the like.

### 2. Description of the Related Art

Japanese Unexamined Patent Application Publication No. 2010-64821 (hereinafter referred to as Patent Literature 1) discloses an escalator monitoring system in which behavior of a passenger is detected by at least two cameras disposed at places where a whole escalator can be monitored and audio or visual warning processing is performed in accordance with the behavior of the passenger.

Japanese Unexamined Patent Application Publication No. 2010-215317 (hereinafter referred to as Patent Literature 2) discloses an escalator alerting apparatus that detects a user who is trying to get on an escalator with an infant in a stroller by using image recognition means and heat detection means and announces a predetermined alert message.

### SUMMARY

One non-limiting and exemplary embodiment provides an information providing method and the like that make it possible to give an alert more suitable for a way in which a user of a vehicle uses an escalator.

In one general aspect, the techniques disclosed here feature an information providing method including causing a computer to: acquire first information concerning a person present in a first area of an escalator; acquire second information concerning the person present in a second area of the escalator; acquire third information concerning a vehicle present on the escalator that is relevant to at least one of the first information or the second information; determine a change in state of the vehicle on the basis of the third information; and output notification information indicative of notification contents decided on the basis of the determined change in state of the vehicle.

According to the present disclosure, it is possible to give an alert more suitable for a way in which a user of a vehicle uses an escalator.

It should be noted that general or specific embodiments may be implemented as an apparatus, a method, a system, an integrated circuit, a computer program, a computer-readable recording medium, or any selective combination thereof. Examples of the computer-readable recording medium include a non-volatile recording medium such as a compact disc-read only memory (CD-ROM).

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view illustrating an example of an environment in which an information providing system according to Embodiment 1 is used;

FIG. 2 is a block diagram illustrating an example of a functional configuration of the information providing system according to Embodiment 1;

FIG. 3A is a schematic view illustrating an example of erroneous detection of a vehicle;

FIG. 3B is a schematic view illustrating an example of failure to detect a vehicle;

FIG. 4 is a schematic view illustrating an example of failure to detect a vehicle in a case where an IC tag is used;

FIGS. 5A to 5C are schematic views illustrating an example of determination by a determination unit according to Embodiment 1;

FIG. 6 illustrates an example of a notification contents database according to Embodiment 1;

FIG. 7 is a flowchart illustrating an example of an overall flow of processing of the information providing system according to Embodiment 1;

FIG. 8A is a schematic view illustrating a first installation example of a first sensor and a second sensor according to Embodiment 1;

FIG. 8B is a schematic view illustrating a second installation example of the first sensor and the second sensor according to Embodiment 1;

FIG. 8C is a schematic view illustrating a third installation example of the first sensor and the second sensor according to Embodiment 1;

FIG. 8D is a schematic view illustrating a fourth installation example of the first sensor and the second sensor according to Embodiment 1;

FIG. 9 is a schematic view illustrating an example of a change in shape of a vehicle according to Embodiment 2;

FIG. 10 is a block diagram illustrating an example of a configuration for detecting a change in state of a vehicle by using an IC tag according Embodiment 2;

FIGS. 11A to 11C are schematic views illustrating an example of determination by a determination unit according to Embodiment 2;

FIG. 12 illustrates an example of a notification contents database according to Embodiment 2;

FIG. 13 is a flowchart illustrating an example of processing of a part of the information providing system according to Embodiment 2;

FIG. 14 illustrates an example of feature information according to a first example of Embodiment 3;

FIG. 15A illustrates an example of a notification contents database according to the first example of Embodiment 3;

FIG. 15B illustrates an example of an attention attracting message contents database according to the first example of Embodiment 3;

FIG. 16 illustrates an example of a notification contents database according to a second example of Embodiment 3;

FIG. 17 is a flowchart illustrating an example of processing of a part of an information providing system according to the first example and the second example of Embodiment 3;

FIG. 18 illustrates an example of a notification contents database according to a third example of Embodiment 3;

FIG. 19 is a flowchart illustrating an example of processing of a part of an information providing system according to the third example of Embodiment 3;

FIG. 20 is a schematic view illustrating an example of a rental area for renting a vehicle according to Embodiment 4;

FIG. 21 is a schematic view illustrating an example of an environment in which an information providing system according to Embodiment 4 is used;

FIG. 22 is a block diagram illustrating an example of functional configurations of the information providing system and an operation terminal according to Embodiment 4;

FIG. 23A illustrates an example of a notification contents database according to Embodiment 4;

FIG. 23B illustrates an example of a message text database according to Embodiment 4;

FIG. 23C illustrates an example of a nationality-language database according to Embodiment 4;

FIG. 23D illustrates an example of a rental database according to Embodiment 4;

FIG. 23E illustrates an example of a user database according to Embodiment 4;

FIG. 23F illustrates an example of a vehicle database according to Embodiment 4;

FIG. 24 is a flowchart illustrating an example of processing of the information providing system according to Embodiment 4;

FIG. 25 is a block diagram illustrating an example of functional configurations of an information providing system and an information terminal according to Embodiment 5;

FIG. 26 illustrates an example of what is displayed on the information terminal according to Embodiment 5;

FIG. 27 is a schematic view illustrating an example of an environment in which an information providing system according to Embodiment 6 is used;

FIG. 28A illustrates an example of a notification contents database for a first escalator according to Embodiment 6;

FIG. 28B illustrates an example of a notification contents database for a second escalator according to Embodiment 6;

FIG. 29 is a block diagram illustrating an example of a functional configuration of an information providing system according to Embodiment 7;

FIGS. 30A and 30B are schematic views illustrating an example of operation of the information providing system according to Embodiment 7; and

FIG. 31 is a flowchart illustrating an example of processing of the information providing system according to Embodiment 7.

### DETAILED DESCRIPTIONS

### Underlying Knowledge Forming Basis of the Present Disclosure

In recent years, there are accidents in which a user of a vehicle such as a stroller or a wheelchair falls down on an escalator or falls off an escalator. Such an accident happens, for example, because a user of a vehicle such as a stroller uses an escalator with a person or baggage on the vehicle.

For example, many escalators installed in public facilities and the like make an alerting announcement. However, some users do not notice the announcement or ignore the announcement. This is considered to happen because of the following reasons. First, an alert is issued even in a case where a user of a vehicle who just passes by an escalator and does not use the escalator is erroneously detected. In this case, the announcement is made not only to the user of the vehicle, but also to other persons. This decreases effectiveness of the announcement, leading to the situation where a user does not notice the announcement or ignores the announcement. Second, in a case where a vehicle is overlooked by being blocked by another user in a crowded condition, even a user who uses an escalator with a person or baggage on the vehicle is not alerted. In this case, the user of the vehicle does not hear the alerting announcement in the first place.

Third, a user of a vehicle such as a stroller or a wheelchair can use an escalator by taking a person or baggage out of the vehicle and folding the vehicle. If an alert is given not only to a user who uses an escalator with a person or baggage on a vehicle, but also to such a good user, such a good user may feel offended. In this case, the user may regard the alert as untrustworthy.

It is therefore necessary to improve accuracy of detection of a user of a vehicle who uses an escalator, for example, by distinguishing a user who uses an escalator with a person or baggage on a vehicle and a good user and to give an alert suitable for a way in which a user of a vehicle uses an escalator.

Patent Literature 1 detects a user who gets on an escalator with an infant in a stroller and gives a predetermined alert. According to Patent Literature 1, an alert is always given in a case where an infant in a stroller is detected. That is, Patent Literature 1 does not consider at all a case where a user of a vehicle who just passes by an escalator and does not use an escalator is erroneously detected and a case where a vehicle is overlooked by being blocked by another user in a crowded condition. Furthermore, Patent Literature 1 does not consider at all a case where an infant in a stroller is detected, but a user of the vehicle takes the person or baggage out of the vehicle and folds the vehicle immediately before using an escalator.

According to Patent Literature 2, users of an escalator are given different levels of alerts. However, Patent Literature 2 does not consider at all behavior which a user of a vehicle such as a stroller or a wheelchair exhibits when using an escalator.

As described above, there are demands for further improvement of an alert given to a person who uses an escalator with a person or baggage on a vehicle.

In order to solve such a problem, an information providing method according to an aspect of the present disclosure includes causing a computer to: acquire first information concerning a person present in a first area of an escalator; acquire second information concerning the person present in a second area of the escalator; acquire third information concerning a vehicle present on the escalator that is relevant to at least one of the first information or the second information; determine a change in state of the vehicle on the basis of the third information; and output notification information indicative of notification contents decided on the basis of the determined change in state of the vehicle.

This makes it possible to give an alert suitable for a way in which a user of a vehicle uses an escalator.

The state of the vehicle may include presence or absence of the vehicle. For example, the vehicle may be at least one of a wagon, a cart, or a stroller.

This makes it possible to give an alert that takes into consideration a possibility that a user of a vehicle who just passes by an escalator and does not use the escalator has been erroneously detected or a possibility that a vehicle has been overlooked by being blocked by another user in a crowded condition.

The computer may acquire the first information and the third information from an image taken by a first camera that images the first area and acquire the second information and the third information from an image taken by a second camera that images the second area.

This makes it possible to give an alert while distinguishing a case where a user of a vehicle who just passes by an escalator and does not use the escalator has been erroneously detected and a case where a vehicle has been overlooked by being blocked by another user in a crowded condition.

The vehicle may have an IC tag in which information concerning the state of the vehicle is recorded. The computer may acquire the third information by reading the information from the IC tag by a tag reader.

This is more likely to increase accuracy of the acquired third information than in a case where the third information is acquired from an image taken by a camera.

The computer may acquire the third information by detecting the first area from a first direction and acquires the third information by detecting the second area from a second direction. The first direction and the second direction may be different.

This makes it possible to lower a possibility of overlooking a vehicle. For example, assume that another user is present ahead of a user of a vehicle. In a case where the first area is detected from the first direction, the other user present ahead of the vehicle blocks the vehicle and makes it hard to detect the vehicle in a crowded condition, leading to a possibility of failure to detect the vehicle. However, according to such a configuration, the first area is detected from the first direction, and the second area is detected from the second direction different from the first direction, and therefore even in a case where the vehicle is overlooked by being blocked by the other user in the first area, the vehicle can be detected in the second area without being blocked by the other user.

The change in state of the vehicle may include a change in shape of the vehicle.

This makes it possible to give an alert more suitable for a way in which a user of a vehicle uses an escalator on the basis of a change in shape of the vehicle.

The change in shape of the vehicle may be a change in shape caused by folding the vehicle.

This makes it possible to give a weaker alert to a user who has folded his or her vehicle, thereby making it less likely to offend a good user of a vehicle.

The third information may include fourth information indicative of a shape of the vehicle at a time of acquisition of the first information and fifth information indicative of a shape of the vehicle at a time of acquisition of the second information. The computer may specify the change in shape of the vehicle on the basis of the fourth information and the fifth information.

This makes it possible to give an alert while taking into consideration a case where a user of a vehicle has taken out a person or baggage from the vehicle and folded the vehicle immediately before using an escalator.

For example, assume that the first area is located close to an entrance of the escalator and the second area is located at or beyond an intermediate point of the escalator. Assume that the user of the vehicle changes the shape of the vehicle immediately before getting on the escalator. In this case, there is a high possibility that in the first area, the vehicle is detected in a shape undesirable for use of an escalator, for example, in an opened state. However, there is a high possibility that in the second area, the vehicle can be detected in a shape desirable for use of an escalator, for example, in a folded state. This makes it possible to determine whether or not the body shape of the vehicle has changed to a shape desirable for use of an escalator by using the fourth information acquired in the first area and the fifth information acquired in the second area.

The computer may further acquire feature information indicative of a feature of at least one of the person or the vehicle. The notification contents may be decided on the basis of the feature information.

This makes it possible to include a sentence expressing a feature of the user of the vehicle in an alert message. This makes it easier for the user of the vehicle to notice that the alert message is intended for him or her when the alert message is given. That is, it is possible to increase an effect of the alert.

The feature information may include at least one of information concerning clothes of the person or information concerning a type of the vehicle.

This makes it possible to include a sentence expressing clothes of the user of the vehicle or a type of vehicle in an alert message. This makes it easier for the user of the vehicle to notice that the alert message is intended for him or her when the alert message is given. That is, it is possible to further increase an effect of the alert.

The feature information may include language information concerning a language which the person can understand. The notification contents may be decided on the basis of the language information.

This makes it possible to include a sentence expressed in a language which the user of the vehicle can understand in an alert message. This makes it easier for the user of the vehicle to notice that the alert message is intended for him or her when the alert message is given. That is, it is possible to further increase an effect of the alert.

The feature information may include relevant person information concerning a relevant person relevant to the person. The notification contents may be decided on the basis of the relevant person information.

This makes it possible to give an alert message according to the number of persons including the user of the vehicle and the relevant person, thereby increasing an effect of the alert.

In general, even in a case where the user uses the escalator after changing the shape of the vehicle into a desirable shape, the escalator can be used more safely as the number of persons relevant to the vehicle including the user of the vehicle becomes larger. Therefore, in a case where the number of relevant persons including the user of the vehicle is small, a stronger alert may be given.

The feature information may further include state information indicative of a state of the person. The notification information may be output from at least one of a speaker or a display on the basis of the state information.

This makes it possible to output an alert message from an appropriate device, for example, in accordance with a state of the user of the vehicle, the relevant person, a person on the vehicle, or the like. This makes it easier for the user of the vehicle to notice that the alert message is intended for him or her, thereby increasing the effect of the alert.

The state information may include at least one of information indicative of an awake state or an asleep state of a person on the vehicle or information indicative of a state concerning sight or hearing of the person.

This makes it possible to output an alert message from an appropriate device in accordance with a state of the user of the vehicle, a person on the vehicle, or the like.

For example, even in a case where the user of the vehicle cannot hear the alert message from a speaker because the user is wearing earphones or the like, the user can notice the alert message displayed on a display. On the other hand, even in a case where the display does not come into field of vision of the user of the vehicle because the user is looking at a smartphone or the like, the user can notice the alert message from the speaker.

In a case where an infant or the like on the vehicle is asleep, the user of the vehicle can be alerted without awakening the infant by displaying an alert message on the display.

The vehicle may be a rental vehicle; the feature information may include an identifier of the rental vehicle; and the notification contents may be decided on the basis of user information concerning the person who has rented the rental vehicle corresponding to the identifier of the rental vehicle. For example, the user information may include at least one of passport information concerning the person including nationality or rental registration information concerning the person registered when the rental vehicle is rented.

This makes it possible to give an alert to a temporary user of the vehicle even in a case where the vehicle is a rental vehicle.

The computer may transmit the notification information to an information terminal which the person or a person relevant to the person possesses.

This makes it easier for, for example, the user of the vehicle or the relevant person to notice the alert message.

The escalator may include a first escalator and a second escalator that is successive to the first escalator on a front side in a traveling direction of the person. The computer may decide the notification contents for the second escalator on the basis of the notification contents decided for the first escalator.

This makes it possible to decide new notification contents for the second escalator in consideration of whether or not an alert message at the first escalator was effective. For example, escalators for moving to other floors in a multistory building are often provided successively. In this case, in a case where the state of the vehicle is undesirable at the second escalator even though an alert was given at the first escalator, a stronger alert can be given.

In a case where the third information indicative of presence of the vehicle is acquired at a first time of acquisition of the first information, the computer may store the first information in a first storage in association with the third information and store the second information acquired a predetermined period later than the first time in a second storage in association with the third information; and in a case where the third information indicative of presence of the vehicle is acquired at a second time of acquisition of the second information, the computer may store the second information in the second storage in association with the third information and store the first information acquired a predetermined period earlier than the second time in the first storage in association with the third information.

This makes it possible to collect data for increasing accuracy of detection of a vehicle. For example, a vehicle detected in the first area is likely to be present in the second area after a certain period. Therefore, there is a possibility that the second information acquired after the certain period includes information indicative of the vehicle such as an image of the vehicle irrespective of whether or not the vehicle is detected in the second area. In a case where such data is accumulated and is, for example, used as learning data for a detection system using machine learning, an improvement in accuracy of detection of a vehicle can be expected.

The predetermined period may be decided on the basis of an operating speed of the escalator.

With this configuration, in a case where the vehicle is detected in the first area and is not detected in the second area, second information and third information at a time when the user of the vehicle reaches the second area can be recorded in the second storage at an appropriate timing, for example, even in a case where a speed of the escalator dynamically changes. Similarly, in a case where the vehicle is not detected in the first area and is detected in the second area, first information and third information at a time when the user of the vehicle reaches the first area can be recorded in the first storage at an appropriate timing.

An information providing system according to an aspect of the present disclosure includes a first information acquirer that acquires first information concerning a person present in a first area of an escalator; a second information acquirer that acquires second information concerning the person present in a second area of the escalator; a third information acquirer that acquires third information concerning a vehicle present on the escalator that is relevant to at least one of the first information or the second information; a determiner that determines a change in state of the vehicle on the basis of the third information; a notification contents decider that decides notification contents on the basis of the determined change in state of the vehicle; and an output unit that outputs notification information indicative of the decided notification contents.

This makes it possible to give an alert more suitable for a way in which the user of the vehicle uses an escalator.

A non-transitory computer-readable recording medium according to an aspect of the present disclosure stores a program causing a computer to: acquire first information concerning a person present in a first area of an escalator; acquire second information concerning the person present in a second area of the escalator; acquire third information concerning a vehicle present on the escalator that is relevant to at least one of the first information or the second information; determine a change in state of the vehicle on the basis of the third information; and output notification information indicative of notification contents decided on the basis of the determined change in state of the vehicle.

This makes it possible to give an alert more suitable for a way in which the user of the vehicle uses an escalator.

The present disclosure can be realized as a computer program for causing a computer to execute characteristic processing included in the information providing method of the present disclosure. Needless to say, such a computer program may be distributed by using a computer-readable non-transitory recording medium such as a CD-ROM or over a communication network such as the Internet.

Embodiments are specifically described below with reference to the drawings.

Each of the embodiments described below illustrates a general or specific example of the disclosure. Numerical values, shapes, constituent elements, steps, the order of steps, and the like illustrated in the embodiments below are examples and do not limit the present disclosure. Among constituent elements in the embodiments below, constituent elements that are not described in independent claims indicating highest concepts are described as optional constituent elements. Contents of the embodiments may be combined. The drawings are schematic views and are not necessarily strict illustration. In the drawings, identical constituent members are given identical reference signs.

An information providing system according to an embodiment of the present disclosure may be configured such that all constituent elements are included in a single computer or may be configured such that the constituent elements are distributed into computers.

In the specification, claims, abstract, and drawings of the present application, “at least one of A or B” means “A or B or A and B”.

### Embodiment 1

### 1. Overview

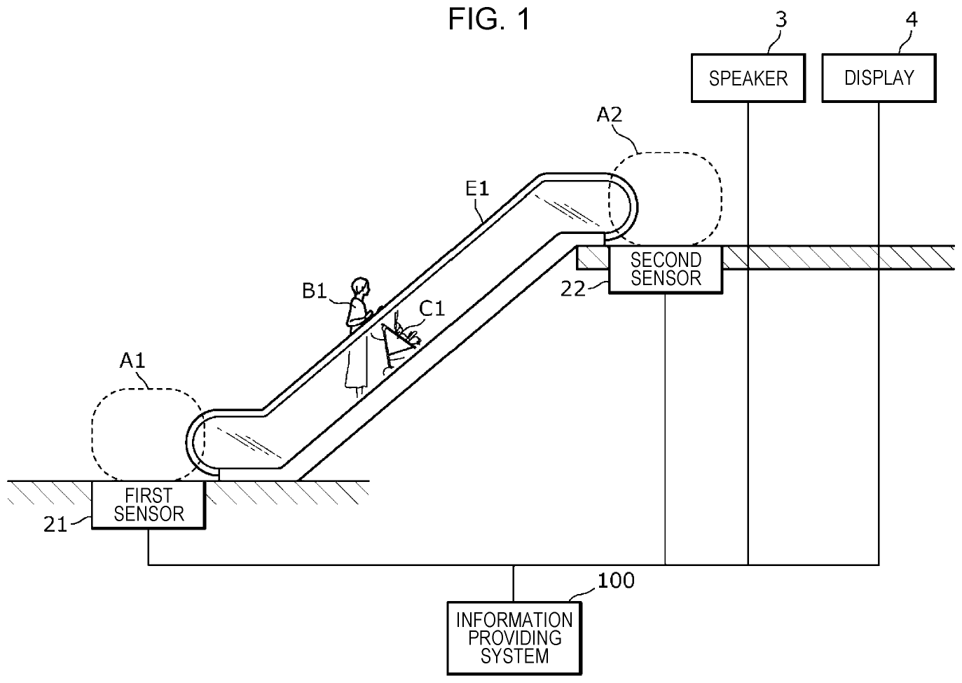

FIG. 1 is a schematic view illustrating an example of an environment in which an information providing system 100 according to Embodiment 1 is used. The information providing system 100 is a system for giving an alert suitable for a way in which a user (person) B1 of a vehicle C1 uses an escalator E1.

In the example illustrated in FIG. 1, the escalator E1 is an up escalator. Although it is assumed in the following description that the escalator E1 is an up escalator, the escalator E1 may be a down escalator or may be a horizontal escalator (moving walk) or the like. Furthermore, the escalator E1 may be an escalator combining an up (or down) escalator and a horizontal escalator.

In the example illustrated in FIG. 1, the vehicle C1 is a stroller. Although it is assumed in the following description that the vehicle C1 is a stroller unless otherwise specified, the vehicle C1 may be, for example, a wagon, a cart, or the like. In other words, the vehicle C1 is at least one of a wagon, a cart, or a stroller. Examples of the cart include a wheelchair, a carrying cart, a shopping cart, and a trolley.

Examples of the user B1 of the vehicle C1 include a person who owns the vehicle C1, for example, by purchasing the vehicle C1 and a person who is temporarily using the vehicle C1, for example, by renting the vehicle C1. In the following description, it is assumed that the user B1 of the vehicle C1 is a person who owns the vehicle C1, unless otherwise specified.

The user B1 can be alerted through hearing of the user B1, for example, by outputting notification information calling for attention as voice. The user B1 can be alerted through sight of the user B1, for example, by outputting notification information calling for attention on a display device. In Embodiment 1, a speaker 3 and a display 4 are installed close to an exit of the escalator E1, and the user B1 is alerted by outputting notification information through the speaker 3 or the display 4. That is, the user B1 is alerted after finishing using the escalator E1. Note that the user B1 may be alerted while the user B1 is using the escalator E1.

### 2. Configuration of Information Providing System

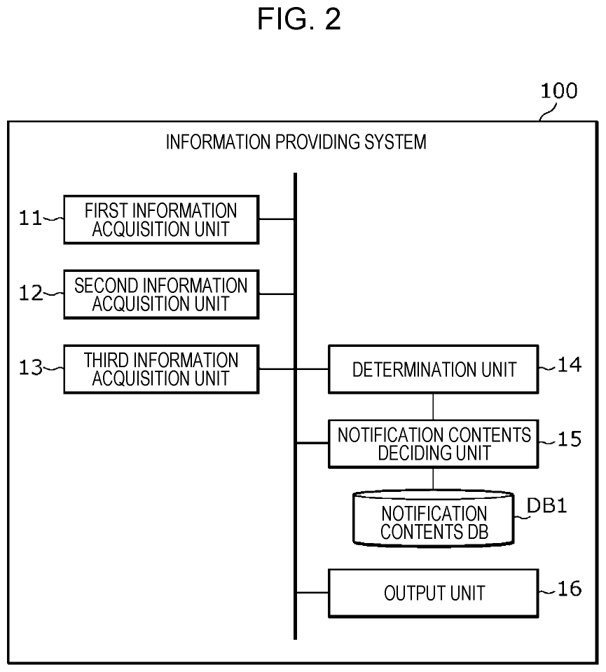

The information providing system 100 according to Embodiment 1 is described below mainly with reference to FIGS. 1 and 2. FIG. 2 is a block diagram illustrating an example of a functional configuration of the information providing system 100 according to Embodiment 1. The information providing system 100 is, for example, a computer such as a personal computer or a server. As illustrated in FIG. 2, the information providing system 100 includes a first information acquisition unit 11, a second information acquisition unit 12, a third information acquisition unit 13, a determination unit 14, a notification contents deciding unit 15, and an output unit 16.

The information providing system 100 further includes a notification contents database DB1. The notification contents database DB1 is, for example, stored in a recording medium such as a hard disk drive, a random access memory (RAM), a read only memory (ROM), or a semiconductor memory. Note that the recording medium may be volatile or may be non-volatile. Other databases described below are also stored in the same recording medium or in a different recording medium.

The first information acquisition unit 11 acquires first information concerning the user B1 present in a first area A1 of the escalator E1. The first information includes information indicative of the presence or absence of the user B1 in the first area A1.

In the example illustrated in FIG. 1, the first area A1 is a region including an entrance of the escalator E1. Although it is assumed in the following description that the first area A1 is a region including the entrance of the escalator E1, the first area A1 may be a region including an intermediate point of the escalator E1.

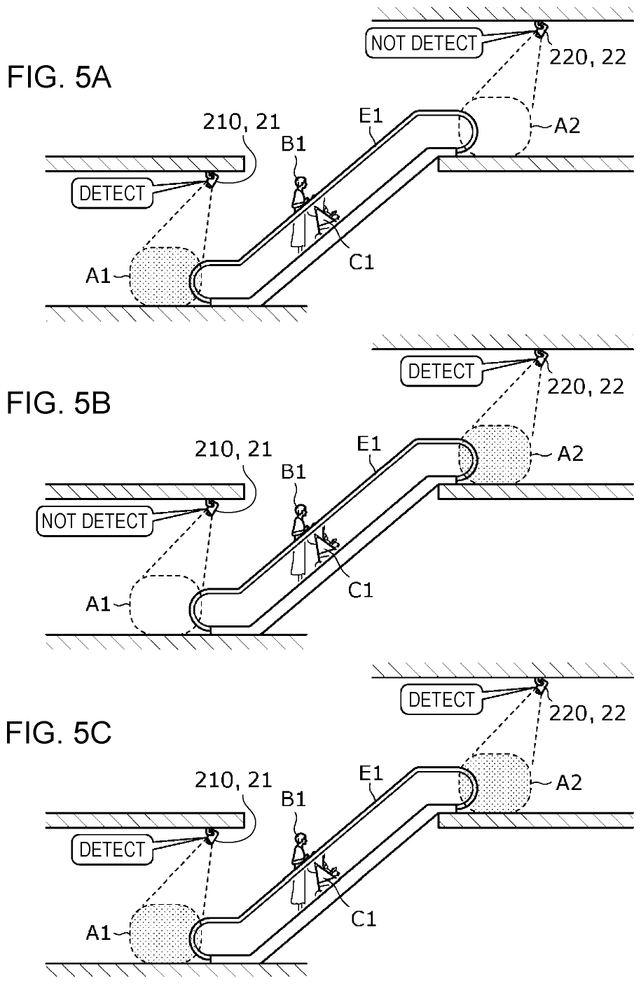

The first information acquisition unit 11 acquires a result of detection using a first sensor 21 whose detection range is the first area A1 through wired communication or wireless communication with the first sensor 21 and thereby acquires the first information. In the following description, it is assumed that the first sensor 21 is a first camera 210 (see FIGS. 5A to 5C) whose imaging range is the first area A1, unless otherwise specified. That is, the first information acquisition unit 11 acquires the first information indicative of the presence or absence of the user B1 in the first area A1 by performing appropriate image analysis processing on an image taken by the first camera 210. The image analysis processing is, for example, performed by a trained model that has been trained by machine learning so as to output a result indicative of the presence or absence of the user B1 in response to an input image.

The information providing system 100 may include computers. The computers may include a computer A. The first information acquisition unit 11 may acquire the first information through the following processes (p1) to (p4).
(p1) The first information acquisition unit 11 receives an image taken by the first camera 210.
(p2) The first information acquisition unit 11 sends the image taken by the first camera 210 to the computer A.
(p3) The computer A decides the first information by performing the image analysis processing.
(p4) The computer A sends the decided first information to the first information acquisition unit 11.

The second information acquisition unit 12 acquires second information concerning the user B1 present in a second area A2 of the escalator E1. The second information includes information indicative of the presence or absence of the user B1 in the second area A2.

In the example illustrated in FIG. 1, the second area A2 is a region including an exit of the escalator E1. The second area A2 is a region which the user B1 reaches after passing the first area A1 in a traveling direction of the user B1. Although it is assumed in the following description that the second area A2 is a region including the exit of the escalator E1, the second area A2 may be a region including an intermediate point of the escalator E1.

The second information acquisition unit 12 acquires a result of detection using a second sensor 22 whose detection range is the second area A2 through wired communication or wireless communication with the second sensor 22 and thereby acquires the second information. In the following description, it is assumed that the second sensor 22 is a second camera 220 (see FIGS. 5A to 5C) whose imaging range is the second area A2, unless otherwise specified. That is, the second information acquisition unit 12 acquires the second information indicative of the presence or absence of the user B1 in the second area A2 by performing appropriate image analysis processing on an image taken by the second camera 220. The image analysis processing is, for example, performed by a trained model that has been trained by machine learning so as to output a result indicative of the presence or absence of the user B1 in response to an input image.

The information providing system 100 may include computers. The computers may include a computer B. The computer B may be the same as the computer A. The second information acquisition unit 12 may acquire the second information through the following processes (q1) to (q4).
(q1) The second information acquisition unit 12 receives an image taken by the second camera 220.
(q2) The second information acquisition unit 12 sends the image taken by the second camera 220 to the computer B.
(q3) The computer B decides the second information by performing the image analysis processing.
(q4) The computer B sends the decided second information to the second information acquisition unit 12.

The third information acquisition unit 13 acquires third information concerning the vehicle C1 present on the escalator E1 that is relevant to at least one of the first information or the second information. The third information includes information indicative of the presence or absence of the vehicle C1 in the first area A1 or information indicative of the presence or absence of the vehicle C1 in the second area A2.

The third information acquisition unit 13 acquires a result of detection using the first sensor 21 through wired communication or wireless communication with the first sensor 21 and thereby acquires the third information. In this example, the third information acquisition unit 13 acquires the third information indicative of the presence or absence of the vehicle C1 in the first area A1 by performing appropriate image analysis processing on an image taken by the first camera 210. Similarly, the third information acquisition unit 13 acquires a result of detection using the second sensor 22 through wired communication or wireless communication with the second sensor 22 and thereby acquires the third information. In this example, the third information acquisition unit 13 acquires the third information indicative of the presence or absence of the vehicle C1 in the second area A2 by performing appropriate image analysis processing on an image taken by the second camera 220. The image analysis processing is, for example, performed by a trained model that has been trained by machine learning so as to output a result indicative of the presence or absence of the vehicle C1 in response to an input image.

The information providing system 100 may include computers. The computers may include a computer C. The computer C may be the same as the computer B. The computer C may be the same as the computer A. The third information acquisition unit 13 may acquire the third information indicative of the presence or absence of the vehicle C1 in the first area A1 through the following processes (r1) to (r4). The “third information indicative of the presence or absence of the vehicle C1 in the first area A1” may mean “the third information indicative of whether or not the first area A1 includes the vehicle C1”.
(r1) The third information acquisition unit 13 receives an image taken by the first camera 210.
(r2) The third information acquisition unit 13 sends the image taken by the first camera 210 to the computer C.
(r3) The computer C decides the third information indicative of the presence or absence of the vehicle C1 in the first area A1 by performing the image analysis processing on the image taken by the first camera 210.
(r4) The computer C sends the decided third information indicative of the presence or absence of the vehicle C1 in the first area A1 to the third information acquisition unit 13.

The information providing system 100 may include computers. The computers may include a computer D. The computer D may be the same as the computer C. The computer D may be the same as the computer B. The computer D may be the same as the computer A. The third information acquisition unit 13 may acquire the third information indicative of the presence or absence of the vehicle C1 in the second area A2 through the following processes (s1) to (s4). The “third information indicative of the presence or absence of the vehicle C1 in the second area A2” may means “the third information indicative of whether or not the second area A2 includes the vehicle C1”.
(s1) The third information acquisition unit 13 receives an image taken by the second camera 220.
(s2) The third information acquisition unit 13 sends the image taken by the second camera 220 to the computer D.
(s3) The computer D decides the third information indicative of the presence or absence of the vehicle C1 in the second area A2 by performing the image analysis processing on the image taken by the second camera 220.
(s4) The computer D sends the decided third information indicative of the presence or absence of the vehicle C1 in the second area A2 to the third information acquisition unit 13.

In Embodiment 1, the computer (the first information acquisition unit 11 and the third information acquisition unit 13) acquires the first information and the third information from an image taken by the first camera 210 that images the first area A1. In Embodiment 1, the computer (the second information acquisition unit 12 and the third information acquisition unit 13) acquires the second information and the third information from an image taken by the second camera 220 that images the second area A2.

As described above, the third information is relevant to at least one of the first information or the second information. For example, in a case where the first information indicates that the user B1 is present in the first area A1 and the third information indicative of the presence of the vehicle C1 in the first area A1 is acquired at a same timing or at an almost same timing as a timing of acquisition of the first information, the third information is relevant to the first information. Similarly, for example, in a case where the second information indicates that the user B1 is present in the second area A2 and the third information indicative of the presence of the vehicle C1 in the second area A2 is acquired at a same timing or at an almost same timing as a timing of acquisition of the second information, the third information is relevant to the second information.

For example, in a case where the user B1 is holding a part of the vehicle C1 or the user B1 is located close to the vehicle C1 in an image taken by the first camera 210, the third information is relevant to the first information. Similarly, for example, in a case where the user B1 is holding a part of the vehicle C1 or the user B1 is located close to the vehicle C1 in an image taken by the second camera 220, the third information is relevant to the second information. As described above, whether the third information is relevant to the first information or the second information is decided by a timing of acquisition of the information or a positional relationship between the user B1 and the vehicle C1.

Note that the first sensor 21 and the second sensor 22 may be, for example, tag readers. A tag reader is a device that acquires information stored in an integrated circuit (IC) tag, which is one kind of radio frequency identification (RFID) tag, by wirelessly communicating with the IC tag.

The IC tag for the first information or the second information is held by the user B1, for example, by being stored in a pocket of clothes, a bag, or the like of the user B1. Note that information stored in the IC tag for the first information or the second information need not be information for identifying the user B1 and need just be information from which a tag reader can know that the user B1 is a person.

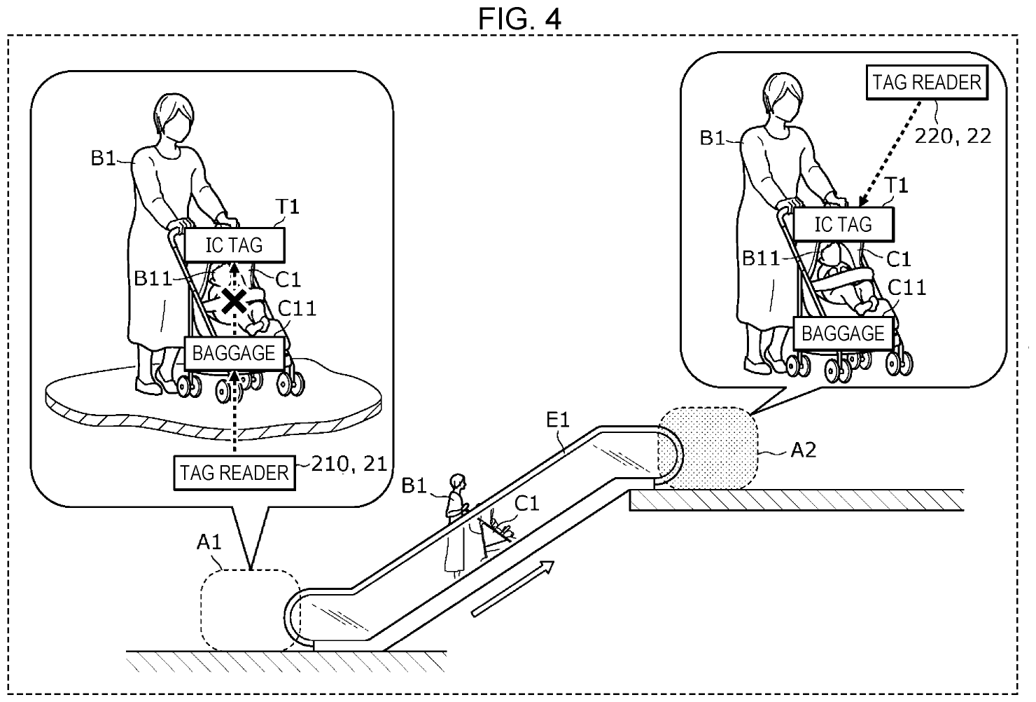

An IC tag T1 (see FIG. 4) for the third information is held by the vehicle C1, for example, by being attached to a handle (grip) of the vehicle C1. Note that information stored in the IC tag T1 for the third information need not be information for identifying the vehicle C1 and need just be information from which a tag reader can know that the vehicle C1 is a vehicle.

That is, in a case where the vehicle C1 has an IC tag T1 in which information concerning a state of the vehicle C1 is recorded, the computer (the third information acquisition unit 13) acquires the third information by reading the information from the IC tag T1 by a tag reader (a first tag reader 211 or a second tag reader 221 (see FIG. 4)).

The first sensor 21 and the second sensor 22 may be sensors that wirelessly communicate with a device such as a smartphone or a wristwatch which the user B1 possesses. In this case, the first sensor 21 and the second sensor 22 detect the presence or absence of the user B1 by communicating with the device and thereby acquiring an identifier of the user B1 stored in the device.

The determination unit 14 determines a change in state of the vehicle C1 on the basis of the third information. In Embodiment 1, the state of the vehicle C1 includes the presence or absence of the vehicle C1. The determination unit 14 determines a change in state of the vehicle C1 on the basis of the third information relevant to the first information and the third information relevant to the second information.

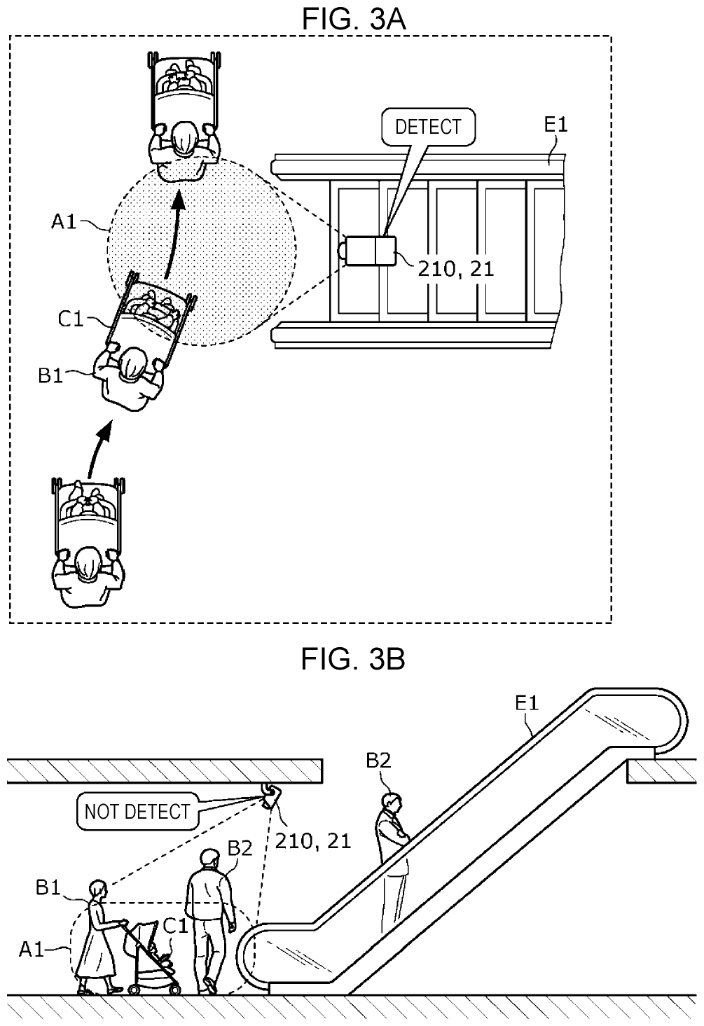

A reason why a change in state of the vehicle C1 is determined by the determination unit 14 is described with reference to FIGS. 3A, 3B, and 4. FIG. 3A is a schematic view illustrating an example of erroneous detection of the vehicle C1. FIG. 3B is a schematic view illustrating an example of a failure to detect the vehicle C1. FIG. 4 is a schematic view illustrating an example of a failure to detect the vehicle C1 in a case where the IC tag T1 is used.

As illustrated in FIG. 3A, for example, the user B1 of the vehicle C1 who does not the escalator E1 may just pass by the entrance of the escalator E1 in some cases. In such a case, the first camera 210 (the first sensor 21) detects the vehicle C1 that passes the first area A1, but the second camera 220 (the second sensor 22) does not detect the vehicle C1 in the second area A2. That is, the vehicle C1 of the user B1 who does not use the escalator E1 is erroneously detected.

As illustrated in FIG. 3B, for example, another user B2 may be present ahead of the user B1 of the vehicle C1, and the vehicle C1 may be blocked by the user B2 and be in a blind spot of the first camera 210 (the first sensor 21) in some cases. In such a case, the first camera 210 does not detect the vehicle C1 in the first area A1, but the second camera 220 (the second sensor 22) detects the vehicle C1 in the second area A2. That is, the vehicle C1 of the user B1 who uses the escalator E1 is overlooked in the first area A1. As illustrated in FIG. 4, for example, the IC tag T1 may be held by the vehicle C1 and baggage C11 made of a metal may be on the vehicle C1 in some cases. In such a case, in a case where the first tag reader 211 (the first sensor 21) is disposed under floor in the first area A1, wireless communication between the first tag reader 211 and the IC tag T1 is blocked by the baggage C11, and therefore the first tag reader 211 does not detect the vehicle C1 in the first area A1. On the other hand, in a case where the second tag reader 221 (the second sensor 22) is disposed on a ceiling in the second area A2, wireless communication between the second tag reader 221 and the IC tag T1 is not blocked by the baggage C11, and therefore the second tag reader 221 detects the vehicle C1 in the second area A2. That is, the vehicle C1 of the user B1 who uses the escalator E1 is overlooked in the first area A1.

The determination unit 14 determines a change in state of the vehicle C1 by taking into consideration that the above situations can occur. Specifically, the determination unit 14 determines a change in state of the vehicle C1 as any one of the following first to fourth determination results. Note that in each case, it is assumed that the first information indicates the presence of the user B1 in the first area A1 and the second information indicates the presence of the user B1 in the second area A2.

FIGS. 5A to 5C are schematic views illustrating an example of determination by the determination unit 14 according to Embodiment 1. As illustrated in FIG. 5A, the first determination result is a result showing that the vehicle C1 is detected in the first area A1 but the vehicle C1 is not detected in the second area A2. As illustrated in FIG. 5B, the second determination result is a result showing that the vehicle C1 is not detected in the first area A1 but the vehicle C1 is detected in the second area A2. As illustrated in FIG. 5C, the third determination result is a result showing that the vehicle C1 is detected in both of the first area A1 and the second area A2. The fourth determination result (not illustrated) is a result showing that the vehicle C1 is not detected in the first area A1 nor the second area A2.

The notification contents deciding unit 15 decides notification contents on the basis of the change in state of the vehicle C1 determined by the determination unit 14. Specifically, the notification contents deciding unit 15 decides notification contents by comparing a result of determination performed by the determination unit 14 with the notification contents database DB1.

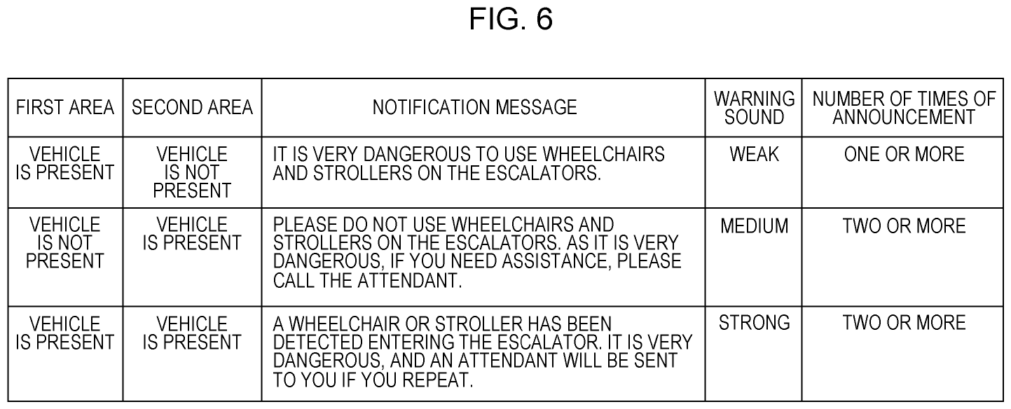

FIG. 6 illustrates an example of the notification contents database DB1 according to Embodiment 1. As illustrated in FIG. 6, in the notification contents database DB1, the presence or absence of the vehicle C1 in the first area A1 and the second area A2 (i.e., a result of determination performed by the determination unit 14) is associated with a notification message, warning sound, and the number of times of announcement. The notification message is a message output as voice from the speaker 3 or a message displayed as a character string or the like on the display 4. The warning sound is sound issued together with the notification message. The number of times of announcement is the number of times of output of the notification message.

In the example illustrated in FIG. 6, “FIRST AREA: VEHICLE IS PRESENT, SECOND AREA: VEHICLE IS NOT PRESENT” in the second row corresponds to the first determination result, “FIRST AREA: VEHICLE IS NOT PRESENT, SECOND AREA: VEHICLE IS PRESENT” in the third row corresponds to the second determination result, and “FIRST AREA: VEHICLE IS PRESENT, SECOND AREA: VEHICLE IS PRESENT” in the fourth row corresponds to the third determination result. Note that in a case where a result of determination performed by the determination unit 14 is the fourth determination result, the user B1 of the vehicle C1 is not present, and therefore no alert is issued. That is, the notification contents deciding unit 15 decides not to give a notification.

For example, in a case where a result of determination performed by the determination unit 14 is the first determination result, the notification contents deciding unit 15 decides to output a notification message “IT IS VERY DANGEROUS TO USE WHEELCHAIRS AND STROLLERS ON THE ESCALATORS.”, issue warning sound of a small (weak) volume, and output the notification message one or more times. In a case where the result of determination performed by the determination unit 14 is the second determination result, the notification contents deciding unit 15 decides to give a stronger alert than in the case of the first determination result. Furthermore, in a case where the result of determination performed by the determination unit 14 is the third determination result, the notification contents deciding unit 15 decides to give a stronger alert than in the case of the second determination result. In this way, the notification contents deciding unit 15 decides to give a stronger alert as probability of the presence of the vehicle C1 on the escalator E1 becomes higher.

The output unit 16 outputs notification information indicative of the notification contents decided by the notification contents deciding unit 15. In Embodiment 1, the output unit 16 outputs the notification information by outputting a notification message of contents decided by the notification contents deciding unit 15 as voice from the speaker 3 and displaying the notification message on the display 4. The output unit 16 outputs the notification information by outputting warning sound of an intensity decided by the notification contents deciding unit 15 from the speaker 3. The warning sound may be output at a same time as the output of the notification message or may be before or after the output of the notification message. The output unit 16 outputs the notification information by outputting the notification message and the warning sound the number of times of announcement decided by the notification contents deciding unit 15.

For example, in a case where the user B1 is detected in the first area A1, the output unit 16 calculates a timing at which the user B1 reaches the second area A2 from an operating speed of the escalator E1, and outputs the notification information at the calculated timing. Alternatively, in a case where the user B1 same as the user B1 detected in the first area A1 is also detected in the second area A2, the output unit 16 may output the notification information at a timing of the detection in the second area A2.

Note that the output unit 16 may display, on the display 4, an image of the user B1 for whom the notification message is intended taken by the first camera 210 (or the second camera 220) together with a character string of the notification message. In this case, the user B1 is more likely to notice that the notification information is being output to the user B1, and an effect of the alert can be further increased.

Note that in a case where the speaker 3 is disposed close to the exit of the escalator E1, the output unit 16 may output the notification information from the speaker 3. Similarly, in a case where the display 4 is disposed close to the exit of the escalator E1, the output unit 16 may output the notification information on the display 4. Furthermore, the output unit 16 may display warning light on the display 4.

### 3. Operation

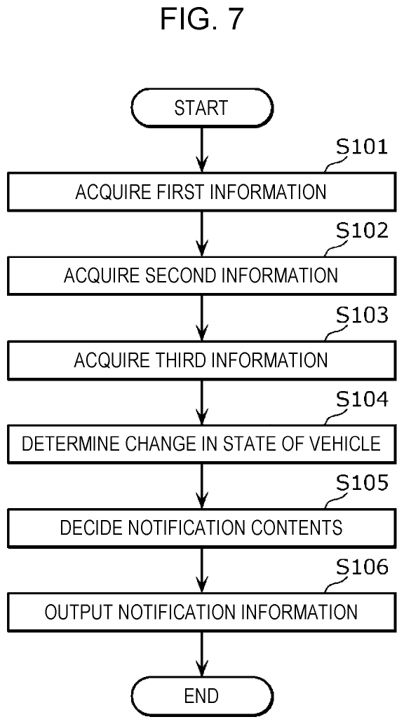

An example of operation of the information providing system 100 according to Embodiment 1 is described below with reference to FIG. 7. FIG. 7 is a flowchart illustrating an example of an overall flow of processing of the information providing system 100 according to Embodiment 1.

First, the first information acquisition unit 11 acquires the first information by acquiring a result of detection using the first sensor 21 (step S101). In this example, the first information acquisition unit 11 acquires the first information indicating that the user B1 is present in the first area A1 of the escalator E1.

The second information acquisition unit 12 acquires the second information by acquiring a result of detection using the second sensor 22 (step S102). In this example, the second information acquisition unit 12 acquires the second information indicating that the user B1 is present in the second area A2 of the escalator E1.

The third information acquisition unit 13 acquires the third information when the first information acquisition unit 11 acquires the first information and acquires the third information when the second information acquisition unit 12 acquires the second information (step S103). In this example, the third information acquisition unit 13 acquires the third information including information indicative of the presence or absence of the vehicle C1 in the first area A1 of the escalator E1 and information indicative of the presence or absence of the vehicle C1 in the second area A2 of the escalator E1.

Next, the determination unit 14 determines a change in state of the vehicle C1 on the basis of the third information (step S104). In this example, the determination unit 14 determines the change in state of the vehicle C1 as any one of the first to fourth determination results on the basis of the presence or absence of the vehicle C1 in the first area A1 of the escalator E1 and the presence or absence of the vehicle C1 in the second area A2 of the escalator E1.

Next, the notification contents deciding unit 15 decides notification contents on the basis of the change in state of the vehicle C1 determined by the determination unit 14 (step S105). The notification contents deciding unit 15 decides notification contents corresponding to any one of the first to third determination results by referring to the notification contents database DB1. Note that in a case where a result of determination performed by the determination unit 14 is the fourth determination result, the notification contents deciding unit 15 decides not to give a notification.

Then, the output unit 16 outputs notification information indicative of the notification contents decided by the notification contents deciding unit 15 (step S106). In this example, the output unit 16 outputs the notification information by outputting a notification message of the contents decided by the notification contents deciding unit 15 as voice from the speaker 3 together with warning sound and displaying the notification message on the display 4.

As described above, in Embodiment 1, the user B1 who uses the escalator E1 can be given a notification according to a change in state of the vehicle C1. Therefore, in Embodiment 1, the user B1 of the vehicle C1 can be given an alert more suitable for a way in which the user B1 uses the escalator E1. Specifically, the user B1 who uses the escalator E1 can be given an alert of stronger notification contents as probability of the presence of the vehicle C1 on the escalator E1 becomes higher.

For example, in a case where the user B1 just passes by the entrance of the escalator E1 and does not use the escalator E1, the notification contents are kept at a typical level of alert, and as a result, the other user B2 is less likely to be offended. For example, even in a case where the vehicle C1 is overlooked at the entrance of the escalator E1, the user B1 of the vehicle C1 can be alerted as long as the vehicle C1 is detected at the exit of the escalator E1. Furthermore, for example, in a case where the vehicle C1 is detected at both of the entrance and the exit of the escalator E1, the user B1 of the vehicle C1 can be given an alert that is as strong as a warning.

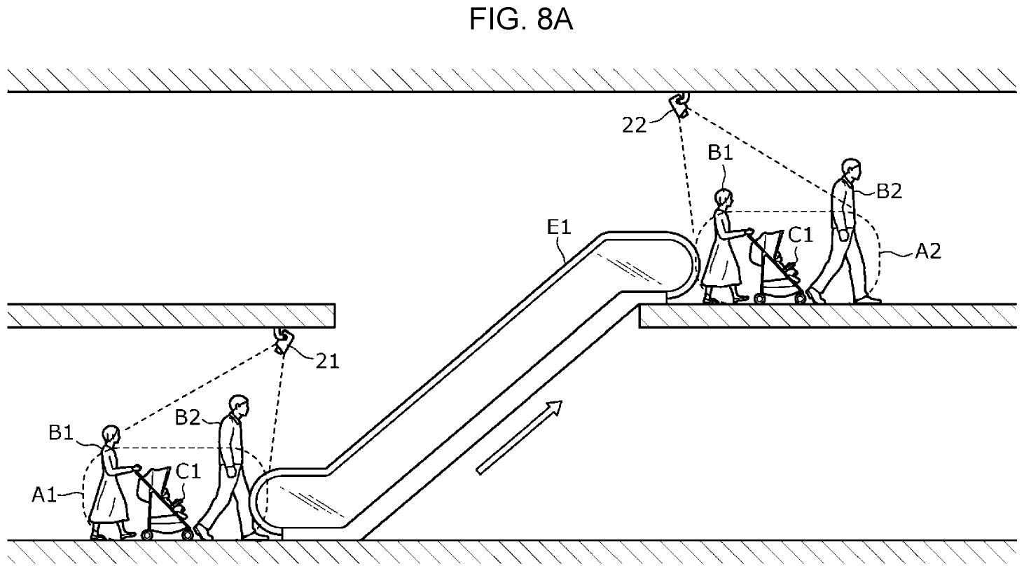

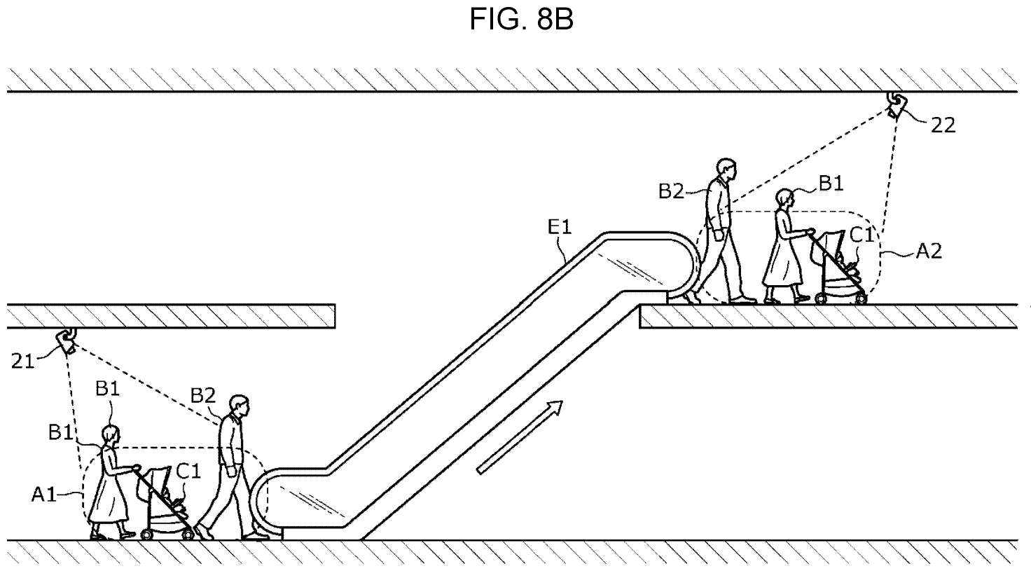

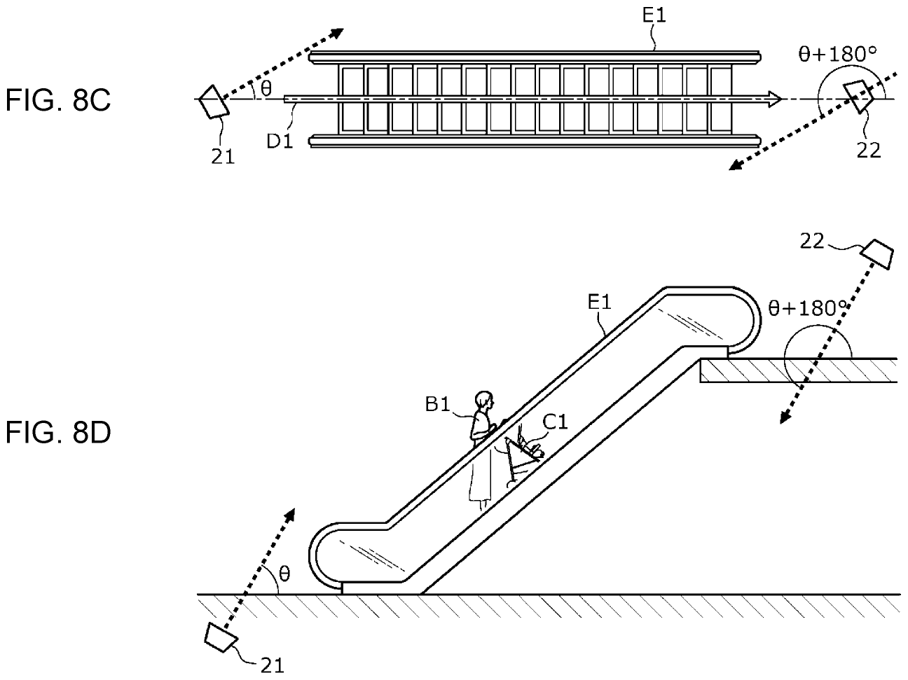

The first sensor 21 and the second sensor 22 may be, for example, installed as illustrated in FIGS. 8A to 8D so that the vehicle C1 can be detected without failure in at least one of the first area A1 or the second area A2 of the escalator E1.

FIG. 8A is a schematic view illustrating a first installation example of the first sensor 21 and the second sensor 22 according to Embodiment 1. In the first installation example, both of the first sensor 21 and the second sensor 22 are installed on a ceiling. The first sensor 21 is disposed so as to capture front sides of the user B1 and the vehicle C1 present in the first area A1 of the escalator E1, and the second sensor 22 is disposed so as to capture back sides of the user B1 and the vehicle C1 present in the second area A2 of the escalator E1.

FIG. 8B is a schematic view illustrating a second installation example of the first sensor 21 and the second sensor 22 according to Embodiment 1. In the second installation example, both of the first sensor 21 and the second sensor 22 are installed on a ceiling. The first sensor 21 is disposed so as to capture back sides of the user B1 and the vehicle C1 present in the first area A1 of the escalator E1, and the second sensor 22 is disposed so as to capture front sides of the user B1 and the vehicle C1 present in the second area A2 of the escalator E1.

FIG. 8C is a schematic view illustrating a third installation example of the first sensor 21 and the second sensor 22 according to Embodiment 1. In the third installation example, both of the first sensor 21 and the second sensor 22 are installed on a ceiling. When the escalator E1 is viewed downward in a vertical direction from the ceiling, the first sensor 21 is disposed so that an angle between a traveling direction D1 of the escalator E1 and a detection direction of the first sensor 21 becomes θ, and the second sensor 22 is disposed so that an angle between the traveling direction D1 and a detection direction of the second sensor 22 becomes θ+180 degrees.

FIG. 8D is a schematic view illustrating a fourth installation example of the first sensor 21 and the second sensor 22 according to Embodiment 1. In the fourth installation example, the first sensor 21 is installed under floor, and the second sensor 22 is installed on a ceiling. When the escalator E1 is viewed sideways in a horizontal direction, the first sensor 21 is disposed so that an angle between a floor surface and a detection direction of the first sensor 21 becomes θ, and the second sensor 22 is disposed so that an angle between the floor surface and a detection direction of the second sensor 22 becomes θ+180 degrees.

As described above, the computer (the third information acquisition unit 13) may acquire the third information by detecting the first area A1 from a first direction by the first sensor 21 and acquire the third information by detecting the second area A2 from a second direction by the second sensor 22. The first direction and the second direction are different. As a result, even in a case where the vehicle C1 cannot be detected in one of the first area A1 and the second area A2, a possibility of detection of the vehicle C1 in the other one of the first area A1 and the second area A2 can be increased, and as a result, a possibility of overlooking the vehicle C1 can be lowered.

### Embodiment 2

An information providing system 100 according to Embodiment 2 is different from the information providing system 100 according to Embodiment 1 in that a determination unit 14 determines a change in state of a vehicle C1 including a change in shape of the vehicle C1. That is, in Embodiment 2, a change in state of the vehicle C1 includes a change in shape of the vehicle C1. In particular, in Embodiment 2, the change in shape of the vehicle C1 is a change in shape caused by folding of the vehicle C1.

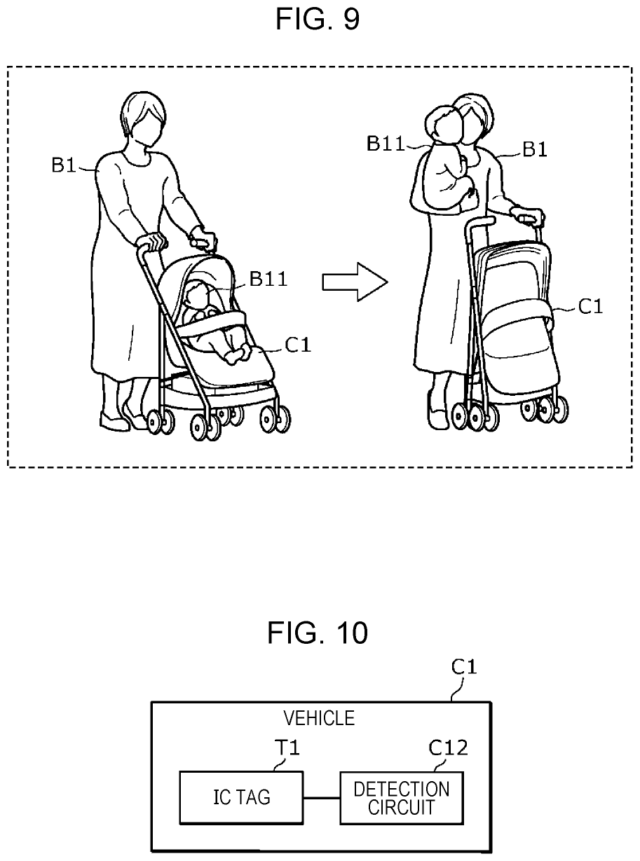

FIG. 9 is a schematic view illustrating an example of a change in shape of the vehicle C1 according to Embodiment 2. As illustrated in FIG. 9, the vehicle C1 (in this example, a stroller) can take two states, i.e., an “opened” state before folding and a “closed” state after folding.

For example, in a case where a user B1 does not use an escalator E1, the user B1 basically uses the vehicle C1 in the “opened” state with a baby B11 or baggage C11 on the vehicle C1. In a case where the user B1 (in this example, the user B1 who has good manners) uses the escalator E1, the user B1 uses the escalator E1 after folding the vehicle C1 into the “closed” state while carrying the baby B11 or the baggage C11 in his or her arm.

In Embodiment 2, a third information acquisition unit 13 acquires, as third information, information indicating whether the vehicle C1 in a first area A1 is in the “opened” state or in the “closed” state by performing appropriate image analysis processing on an image taken by a first camera 210 that images the first area A1. The third information acquisition unit 13 acquires, as third information, information indicating whether the vehicle C1 in a second area A2 is in the “opened” state or in the “closed” state by performing appropriate image analysis processing on an image taken by a second camera 220 that images the second area A2. That is, the third information includes fourth information indicative of a shape of the vehicle C1 at a time of acquisition of first information and fifth information indicative of a shape of the vehicle C1 at a time of acquisition of second information.

The information providing system 100 may include computers. The computers may include a computer E. The computer E may be the same as a computer B. The computer E may be the same as a computer A. The third information acquisition unit 13 may acquire the third information indicating whether the vehicle C1 in the first area A1 is in the “opened” state or in the “closed” state through the following processes (t1) to (t4).
(t1) The third information acquisition unit 13 receives an image taken by the first camera 210.
(t2) The third information acquisition unit 13 sends the image taken by the first camera 210 to the computer E.
(t3) The computer E decides the third information indicating whether the vehicle C1 in the first area A1 is in the “opened” state or in the “closed” state by performing the image analysis processing on the image taken by the first camera 210.
(t4) The computer E sends the decided third information indicating whether the vehicle C1 in the first area A1 is in the “opened” state or in the “closed” state to the third information acquisition unit 13.

The information providing system 100 may include computers. The computers may include a computer F. The computer F may be the same as the computer E. The computer F may be the same as the computer B. The computer F may be the same as the computer A. The third information acquisition unit 13 may acquire the third information indicating whether the vehicle C1 in the second area A2 is in the “opened” state or in the “closed” state through the following processes (u1) to (u4).
(u1) The third information acquisition unit 13 receives an image taken by the second camera 220.
(u2) The third information acquisition unit 13 sends the image taken by the second camera 220 to the computer F.
(u3) The computer F decides the third information indicating whether the vehicle C1 in the second area A2 is in the “opened” state or in the “closed” state by performing the image analysis processing on the image taken by the second camera 220.
(u4) The computer F sends the decided third information indicating whether the vehicle C1 in the second area A2 is in the “opened” state or in the “closed” state to the third information acquisition unit 13.

In some cases, the vehicle C1 is not fully folded, and it is difficult to determine whether the vehicle C1 in the “opened” state or in the “closed” state. In such a case, the third information acquisition unit 13 may acquire, as the fourth information or the fifth information, information indicating that the vehicle C1 is in the “closed” state in a case where the baby B11 and the baggage C11 are not on the vehicle C1. In such a case, the third information acquisition unit 13 may acquire, as the fourth information or the fifth information, information indicating that the vehicle C1 is in the “closed” state in a case where a distance between a front wheel and a rear wheel is smaller than a width of a step of the escalator E1 and the front wheel and the rear wheel of the vehicle C1 are in contact with one step of the escalator E1.

Note that the third information acquisition unit 13 may acquire the fourth information and the fifth information by reading information from an IC tag T1 attached to the vehicle C1 by a tag reader (a first tag reader 211 or a second tag reader 221). In this case, the fourth information and the fifth information need to be stored in the IC tag T1, for example, by a configuration such as the one illustrated in FIG. 10.

FIG. 10 is a block diagram illustrating an example of a configuration for detecting a change in state of the vehicle C1 by using the IC tag T1 according to Embodiment 2. As illustrated in FIG. 10, the vehicle C1 includes a detection circuit C12 that is electrically connected to the IC tag T1. The detection circuit C12 includes, for example, a micro switch that turns on or off depending on whether the vehicle C1 is in the “opened” state or in the “closed” state. A detection result of the micro switch, that is, information (the fourth information and the fifth information) indicating whether the vehicle C1 is in the “opened” state or in the “closed” state is written into the IC tag T1 by the detection circuit C12.

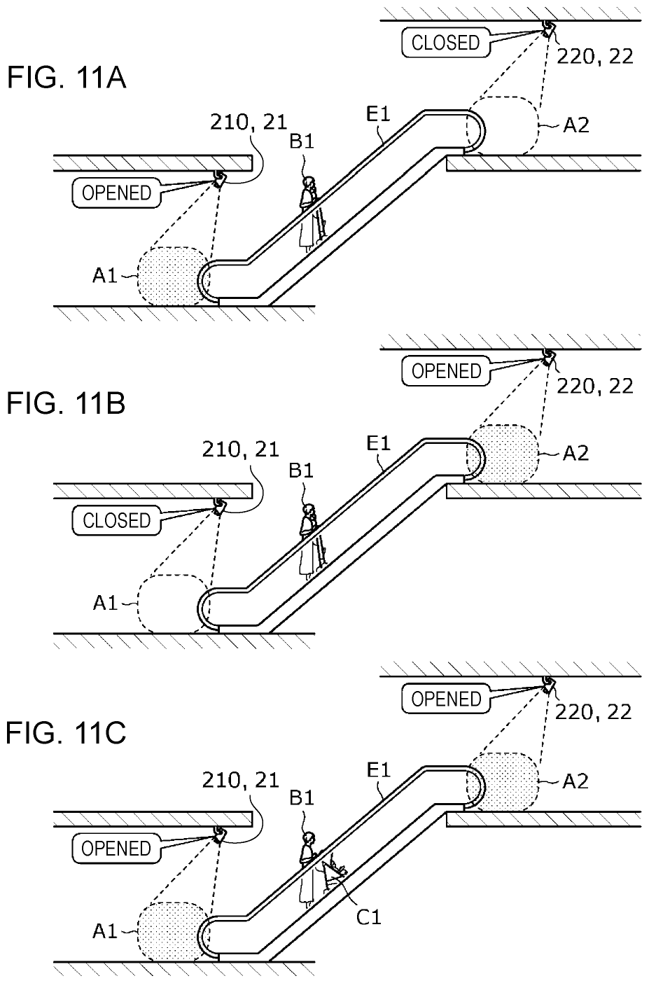

In Embodiment 2, in a case where a result of determination is a third determination result, the determination unit 14 further determines a change in state of the vehicle C1 as any one of the following fifth to eighth determination results. FIGS. 11A to 11C are schematic views illustrating an example of determination performed by the determination unit 14 according to Embodiment 2. The fifth determination result (not illustrated) is a result showing that the vehicle C1 is in the “closed” state in both of the first area A1 and the second area A2. The sixth determination result is a result indicating that the vehicle C1 is in the “opened” state in the first area A1 and the vehicle C1 is in the “closed” state in the second area A2, as illustrated in FIG. 11A. The seventh determination result is a result showing that the vehicle C1 is in the “closed” state in the first area A1 and the vehicle C1 is in the “opened” state in the second area A2, as illustrated in FIG. 11B. The eighth determination result is a result showing that the vehicle C1 is in the “opened” state in both of the first area A1 and the second area A2, as illustrated in FIG. 11C.

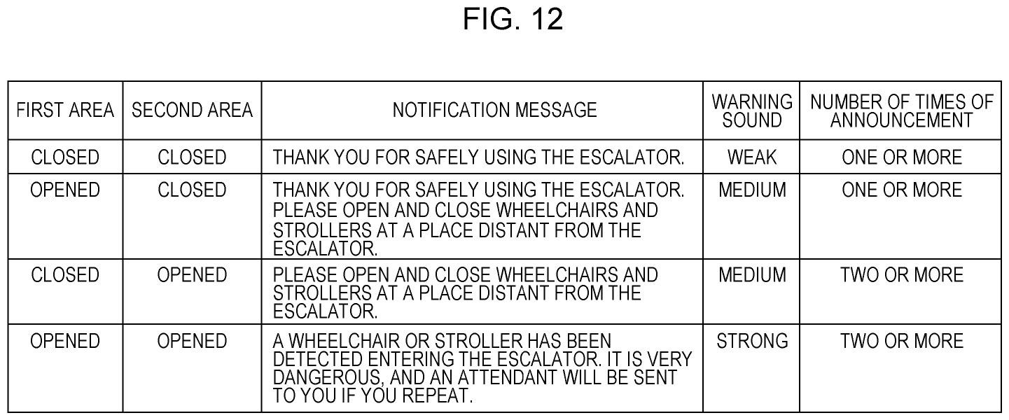

In Embodiment 2, in a case where the result of determination performed by the determination unit 14 is any one of the fifth to eighth determination results, a notification contents deciding unit 15 decides notification contents by comparing the determination result with a notification contents database DB1 illustrated in FIG. 12.

FIG. 12 illustrates an example of the notification contents database DB1 according to Embodiment 2. In the notification contents database DB1 illustrated in FIG. 12, shapes of the vehicle C1 in the first area A1 and the second area A2 are associated with a notification message, warning sound, and the number of times of announcement.

In the example illustrated in FIG. 12, “FIRST AREA: CLOSED, SECOND AREA: CLOSED” in the second row corresponds to the fifth determination result, and “FIRST AREA: OPENED, SECOND AREA: CLOSED” in the third row corresponds to the sixth determination result. “FIRST AREA: CLOSED, SECOND AREA: OPENED” in the fourth row corresponds to the seventh determination result, and “FIRST AREA: OPENED, SECOND AREA: OPENED” in the fifth row corresponds to the eighth determination result.

For example, in a case where the result of determination performed by the determination unit 14 is the fifth determination result, the notification contents deciding unit 15 decides to output a notification message “THANK YOU FOR SAFELY USING THE ESCALATOR.” appreciating good manners, issue warning sound of a small (weak) volume, and output the notification message one or more times. In a case where the result of determination performed by the determination unit 14 is the sixth determination result, the notification contents deciding unit 15 decides to alert the user B1. In a case where the result of determination of the determination unit 14 is the seventh determination result, the notification contents deciding unit 15 decides to alert the user B1 more strongly than the case of the sixth determination result. Furthermore, in a case where the result of determination performed by the determination unit 14 is the eighth determination result, the notification contents deciding unit 15 decides to alert the user B1 more strongly than the case of the seventh determination result. As described above, the notification contents deciding unit 15 decides to give an alert of stronger notification contents as probability that the vehicle C1 is in the “opened” state during use of the escalator E1 becomes higher.

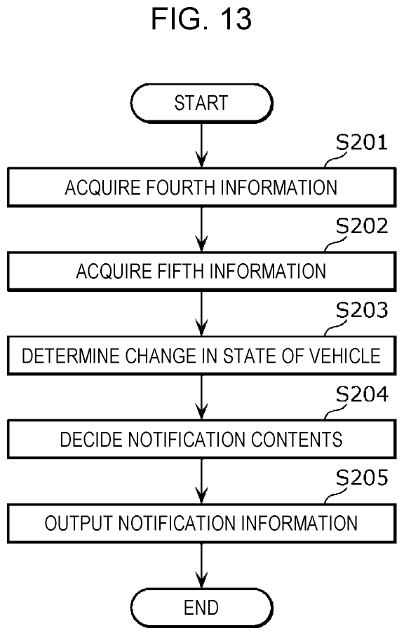

An example of operation of the information providing system 100 according to Embodiment 2 is described with reference to FIG. 13. FIG. 13 is a flowchart illustrating an example of processing of a part of the information providing system 100 according to Embodiment 2. In the following description, it is assumed that the third information acquisition unit 13 has acquired third information indicating that the vehicle C1 is present in both of the first area A1 and the second area A2.

The third information acquisition unit 13 acquires the fourth information by acquiring a result of detection using the first sensor 21 (step S201). The third information acquisition unit 13 acquires the fifth information by acquiring a result of detection using the second sensor 22 (step S202).

Next, the determination unit 14 determines a change in state of the vehicle C1 on the basis of the fourth information and the fifth information (step S203). In this example, the determination unit 14 determines the change in state of the vehicle C1 as any one of the fifth to eighth determination results on the basis of a shape of the vehicle C1 in the first area A1 of the escalator E1 and a shape of the vehicle C1 in the second area A2 of the escalator E1.

Next, the notification contents deciding unit 15 decides notification contents on the basis of the change in state of the vehicle C1 determined by the determination unit 14 (step S204). In this example, the notification contents deciding unit 15 decides notification contents corresponding to the determined one of the fifth to eighth determination results by referring to the notification contents database DB1 illustrated in FIG. 12.

Then, the output unit 16 outputs notification information indicative of the notification contents decided by the notification contents deciding unit 15 (step S205). In this example, the output unit 16 outputs the notification information by outputting a notification message of the contents decided by the notification contents deciding unit 15 as voice from the speaker 3 together with warning sound and displaying the notification message on the display 4.

As described above, in Embodiment 2, the user B1 using the escalator E1 can be given a notification according to a change in shape of the vehicle C1. Therefore, in Embodiment 2, it is possible to give an alert more suitable for a way in which the user B1 of the vehicle C1 uses the escalator E1. Specifically, the user B1 using the escalator E1 can be given an alert of stronger notification contents as probability that the vehicle C1 is in the “opened” state during use of the escalator E1 becomes higher.

Note that even in a case where the vehicle C1 is not detected in the first area A1 and the vehicle C1 is detected in the second area A2, the user B1 can be given an alert according to a shape of the vehicle C1. For example, assume that the third information acquisition unit 13 acquires the fifth information by acquiring a result of detection using the second sensor 22. In this case, in a case where the fifth information indicates that the vehicle C1 is in the “opened” state, the notification contents deciding unit 15 considers that probability that the vehicle C1 is in the “opened” state during use of the escalator E1 is high, and decides to alert the user B1. On the other hand, in a case where the fifth information indicates that the vehicle C1 is in a “closed” state, the notification contents deciding unit 15 considers that probability that the vehicle C1 is in the “closed” state during use of the escalator E1 is high, and decides to appreciate good manners of the user B1.

### Embodiment 3

An information providing system 100 according to Embodiment 3 is different from the information providing system 100 according to Embodiment 1 in that a notification contents deciding unit 15 decides notification contents in accordance with a feature of a user B1 or a vehicle C1. That is, a computer (the information providing system 100) further acquires feature information indicative of a feature of at least one of the user (person) B1 or the vehicle C1. Notification contents are decided on the basis of the feature information.

First to fourth examples of the feature information are described below. Note that the first to fourth examples described below may be combined as appropriate.

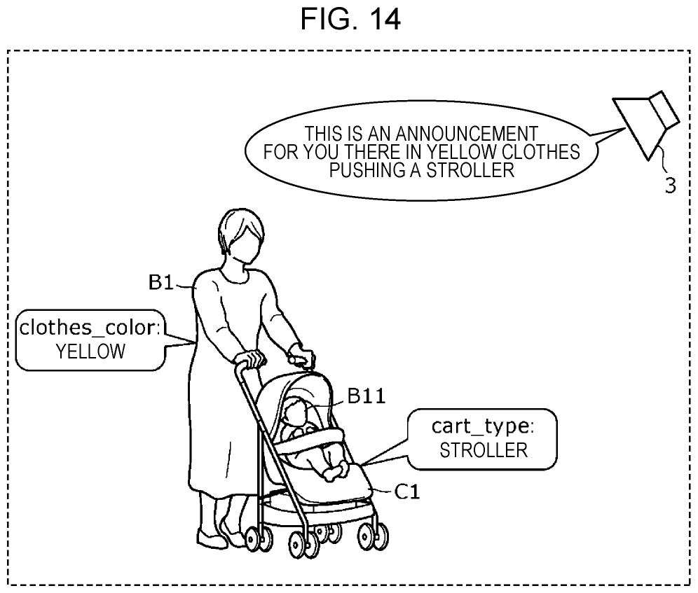

In the first example, the feature information includes at least one of information concerning clothes of the user (person) B1 or information concerning a type of vehicle C1. FIG. 14 illustrates an example of the feature information according to the first example of Embodiment 3. In the example illustrated in FIG. 14, the feature information includes information (clothes_color: yellow) indicating that a color of clothes of the user B1 is yellow and information (cart_type: stroller) indicating that the type of vehicle C1 is a stroller. The feature information illustrated in the first example can be acquired, for example, by performing appropriate image analysis processing on an image taken by a first camera 210 or a second camera 220. In the example illustrated in FIG. 14, the output unit 16 outputs an audio message “THIS IS AN ANNOUNCEMENT FOR YOU THERE IN YELLOW CLOTHES PUSHING A STROLLER” from a speaker 3.

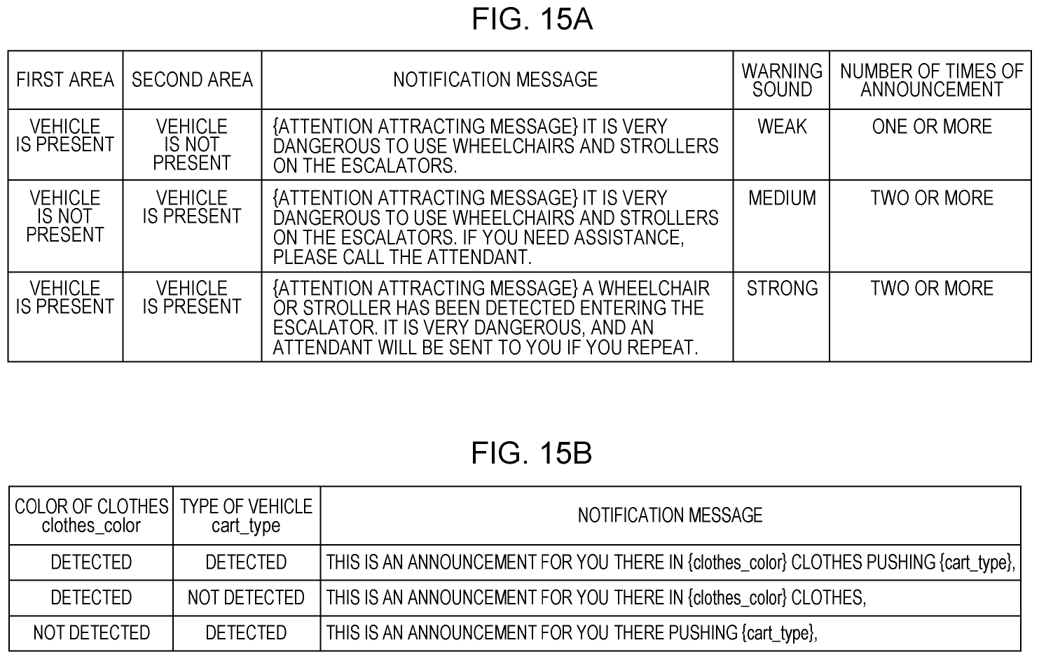

The notification contents are decided as follows. Specifically, in the first example, in a case where a result of determination performed by a determination unit 14 is any one of first to third determination results, the notification contents deciding unit 15 decides the notification contents by comparing the determination result with a notification contents database DB1 illustrated in FIG. 15A. FIG. 15A illustrates an example of the notification contents database DB1 according to the first example of Embodiment 3. The notification contents database DB1 illustrated in FIG. 15A is identical to the notification contents database DB1 illustrated in FIG. 6 except for that a notification message further includes an attention attracting message.

The notification contents deciding unit 15 decides contents of the attention attracting message by comparing the acquired feature information with an attention attracting message contents database illustrated in FIG. 15B. FIG. 15B illustrates an example of the attention attracting message contents database according to the first example of Embodiment 3. As illustrated in FIG. 15B, in the attention attracting message contents database, feature information (the color of the clothes of the user B1 or the type of vehicle C1) is associated with the attention attracting message. For example, in a case where the acquired feature information indicates that the color of the clothes of the user B1 is blue and the type of vehicle C1 is a wheelchair, the notification contents deciding unit 15 decides a message “THIS IS AN ANNOUNCEMENT FOR YOU THERE IN BLUE CLOTHES PUSHING A WHEELCHAIR” as contents of the attention attracting message.

Note that the feature information may include information concerning a sex of the user B1 or information concerning a race of the user B1. In this case, the notification contents deciding unit 15 may decide contents of the attention attracting message on the basis of the sex or race of the user B1.

In the second example, the feature information includes relevant person information concerning a person relevant to the user (person) B1. The notification contents are decided on the basis of the relevant person information. The relevant person is a person accompanying the user B1 such as a spouse, a parent, a relative, or a friend of the user B1.

The relevant person information can be, for example, acquired by performing appropriate image analysis processing on an image taken by the first camera 210 or the second camera 220. More specifically, in a case where a person standing close to the user B1, a person conversing with the user B1, a person facing the user B1, a person holding the baby B11 in his or her arms, or a person giving or receiving something to or from the user B1 is recognized in the taken image, for example, by pattern matching, the computer (the information providing system 100) acquires relevant person information indicating that this person is a relevant person. Note that in a case where there is no person in front of and behind the user B1 in the taken image, the computer (the information providing system 100) acquires relevant person information indicating that there is no relevant person.

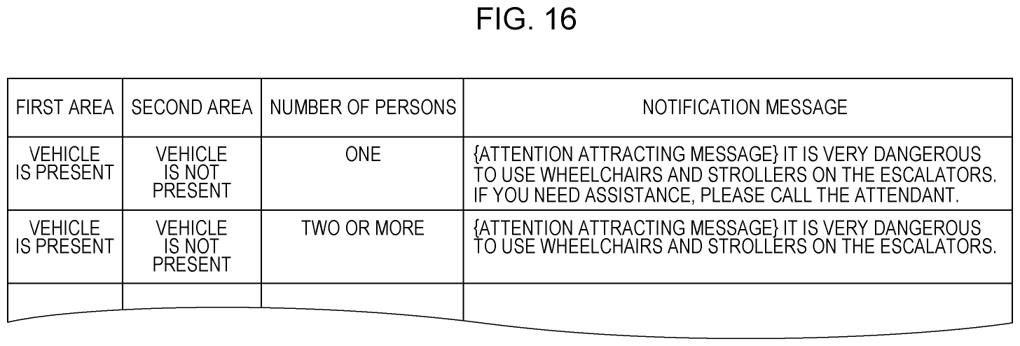

The notification contents are decided as follows. That is, in the second example, in a case where a result of determination performed by the determination unit 14 is any one of the first to third determination results, the notification contents deciding unit 15 decides contents of a notification message by comparing the acquired relevant person information with a notification contents database DB1 illustrated in FIG. 16. FIG. 16 illustrates an example of the notification contents database DB1 according to the second example of Embodiment 3. The notification contents database DB1 illustrated in FIG. 16 is identical to the notification contents database DB1 illustrated in FIG. 6 except for that the number of persons including the user B1 and a relevant person and a notification message are associated. Note that in the example illustrated in FIG. 16, notification messages corresponding to the first determination result are illustrated.

For example, in a case where the relevant person information indicates that there is no relevant person, that is, in a case where the number of persons including the user B1 and a relevant person is one, the notification contents deciding unit 15 decides a message including an additional message prompting a request for assistance “IF YOU NEED ASSISTANCE, PLEASE CALL THE ATTENDANT” as contents of the notification message. On the other hand, in a case where the relevant person information indicates that there is a relevant person, that is, in a case where the number of persons including the user B1 and a relevant person is two or more, the notification contents deciding unit 15 decides a message excluding the message prompting a request for assistance as contents of the notification message.

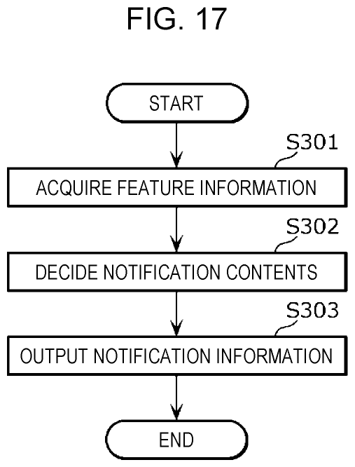

An example of operation of the information providing system 100 in a case where the feature information of the first example or the second example is acquired is described with reference to FIG. 17. FIG. 17 is a flowchart illustrating an example of processing of a part of the information providing system 100 according to the first example and the second example of Embodiment 3. Note that description of a process identical to that of the information providing system 100 according to Embodiment 1 is omitted.

The computer (the information providing system 100) acquires feature information by performing appropriate image analysis processing on an image taken by the first camera 210 or the second camera 220 (step S301).

Next, the notification contents deciding unit 15 decides notification contents on the basis of the feature information (step S302). In a case where the feature information illustrated in the first example is acquired, the notification contents deciding unit 15 decides notification contents by referring to the notification contents database DB1 illustrated in FIG. 15A and the attention attracting message contents database illustrated in FIG. 15B. In a case where the feature information (relevant person information) illustrated in the second example is acquired, the notification contents deciding unit 15 decides notification contents by referring to the notification contents database DB1 illustrated in FIG. 16.

Then, the output unit 16 outputs notification information indicative of the notification contents decided by the notification contents deciding unit 15 (step S303). In this example, the output unit 16 outputs the notification information by outputting a notification message of the contents decided by the notification contents deciding unit 15 as voice from the speaker 3 together with warning sound and displaying the notification message on the display 4.

As described above, in the first example of Embodiment 3, since a notification according to a feature of the user B1 or the vehicle C1 is given, the user B1 is more likely to notice an alert, and therefore an effect of the alert can be further increased. In the second example of Embodiment 3, since an alert according to the number of persons including the user B1 and a relevant person is given, an effect of the alert can be further increased.

Note that in a case where the user B1 possesses an IC tag and feature information is stored in the IC tag, the computer (the information providing system 100) can acquire the feature information by communicating with the IC tag by a tag reader (a first tag reader 211 or a second tag reader 221).

In this case, for example, in a case where information indicative of a name of the user B1 is included in the IC tag, the notification contents deciding unit 15 may decide a message including the name of the user B1 as contents of the attention attracting message. Specifically, in a case where the name of the user B1 is “Suzuki”, the notification contents deciding unit 15 decides a message “Mr. (Ms.) Suzuki” as contents of the attention attracting message. For example, in a case where the IC tag includes information indicative of an address of the user B1, the notification contents deciding unit 15 may decide a message including the address of the user B1 as contents of the attention attracting message. Specifically, in a case where the address of the user B1 is Koto-ku, Tokyo, the notification contents deciding unit 15 decides a message “user from Koto-ku, Tokyo” as contents of the attention attracting message.

In the third example, the feature information further includes state information indicative of a state of the user (person) B1. The notification information is output from at least one of the speaker 3 or the display 4 on the basis of the state information. In this example, the state of the user B1 can include not only a state of the user B1 himself or herself, but also a state of a person on the vehicle C1 of the user B1.

For example, the state information includes at least one of information indicative of an awake state or an asleep state of a person on the vehicle C1 or information indicative of a state concerning sight or hearing of the user B1. That is, the state information can include information indicating whether the person (e.g., a baby B11) on the vehicle C1 is awake or asleep. The state information can include information indicating that the user B1 is not looking ahead, for example, because the user B1 is looking at a smartphone or information indicating that the user B1 is not paying attention to surrounding sound, for example, because the user B1 is wearing headphones. The state information can be, for example, acquired by performing appropriate image analysis processing on an image taken by the first camera 210 or the second camera 220.

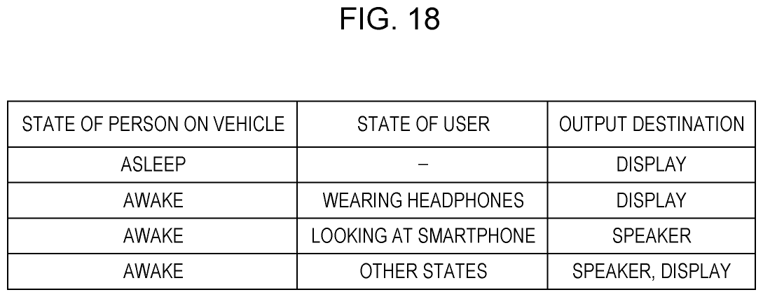

The notification contents are decided as follows. Specifically, in the third example, the notification contents deciding unit 15 decides an output destination to which the notification information is to be output by comparing the acquired state information with a notification contents database DB1 illustrated in FIG. 18. The notification contents database DB1 illustrated in FIG. 18 is identical to the notification contents database DB1 illustrated in FIG. 6 except for that the state information and the output destination to which the notification information is to be output are associated. Note that in the example illustrated in FIG. 18, a correspondence between the state information and the output destination to which the notification information is to be output is illustrated.

For example, in a case where the state information indicates that the person (the baby B11) on the vehicle C1 is asleep, the notification contents deciding unit 15 decides the display 4 as the output destination to which the notification information is to be output. This is to prevent the baby B11 from being awakened by voice output from the speaker 3. For example, in a case where the state information indicates that the person on the vehicle C1 is awake and the user B1 is wearing headphones, the notification contents deciding unit decides the display 4 as the output destination to which the notification information is to be output. This is because the user B1 will not notice surrounding sound. For example, in a case where the state information indicates that the person on the vehicle C1 is awake and the user B1 is watching a smartphone, the notification contents deciding unit 15 decides the speaker 3 as the output destination to which the notification information is to be output. This is because the user B1 does not seem to be looking ahead.

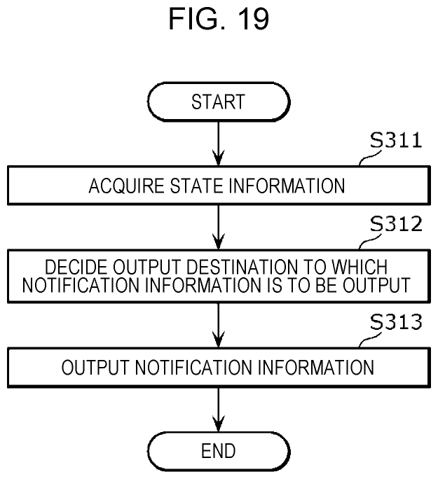

An example of operation of the information providing system 100 in a case where the feature information (state information) of the third example is acquired is described with reference to FIG. 19. FIG. 19 is a flowchart illustrating an example of processing of a part of the information providing system 100 according to the third example of Embodiment 3. Note that description of processing identical to that of the information providing system 100 according to Embodiment 1 is omitted.

The computer (the information providing system 100) acquires the state information by performing appropriate image analysis processing on an image taken by the first camera 210 or the second camera 220 (step S311).

Next, the notification contents deciding unit 15 decides an output destination to which notification information is to be output on the basis of the state information (step S312). In this example, the notification contents deciding unit 15 decides the output destination to which the notification information is to be output by referring to the notification contents database DB1 illustrated in FIG. 18.

Then, the output unit 16 outputs the notification information from the output destination decided by the notification contents deciding unit 15 (step S313). In a case where the output destination decided by the notification contents deciding unit 15 includes the speaker 3, the output unit 16 outputs the notification information by outputting a notification message of the contents decided by the notification contents deciding unit 15 as voice from the speaker 3 together with warning sound. In a case where the output destination decided by the notification contents deciding unit 15 includes the display 4, the output unit 16 outputs the notification information by displaying a notification message of the contents decided by the notification contents deciding unit 15 on the display 4.

As described above, in the third example of Embodiment 3, since a notification according to the state of the user B1 is given, the user B1 is more likely to notice an alert, and an effect of the alert can be further increased.

In the fourth example, the feature information includes language information concerning a language which the user (person) B1 can understand. The notification contents are decided on the basis of the language information. In the fourth example, the language information is, for example, stored in an IC tag possessed by the user B1. The computer (the information providing system 100) can acquire the language information by communicating with the IC tag by a tag reader (the first tag reader 211 or the second tag reader 221).

The notification contents are decided as follows. Specifically, in the fourth example, the notification contents deciding unit 15 decides, as the notification contents, a notification message expressed in a language which the user B1 can understand on the basis of the acquired language information. For example, in a case where the language information indicates English, the notification contents deciding unit 15 decides a notification message expressed in English as the notification contents. Note that details will be described in Embodiment 4.

As described above, in the fourth example of Embodiment, since a notification according to a language which the user B1 can understand is given, the user B1 is more likely to notice an alert, and an effect of the alert can be further increased.

### Embodiment 4

An information providing system 100 according to Embodiment 4 is a system for alerting a user B1 (tourist) in cooperation with a rental service of renting a wheelchair or a stroller mainly to a tourist from abroad, for example, at an airport or the like. Specifically, the information providing system 100 according to Embodiment 4 alerts the user B1 in a language which the user B1 can understand in a case where the user B1 who has rented a vehicle C1 such as a wheelchair or a stroller given an IC tag from a rental area run by the rental service uses an escalator E1.

That is, the vehicle C1 is a rental vehicle, and feature information includes an identifier (in this example, a vehicle ID) of the rental vehicle. Notification contents are decided on the basis of user information concerning the user (person) B1 who has rented a rental vehicle corresponding to an identifier of the rental vehicle. In Embodiment 4, the user information includes at least one of passport information concerning the user (person) B1 including nationality or rental registration information concerning the user (person) B1 registered when the rental vehicle is rented.

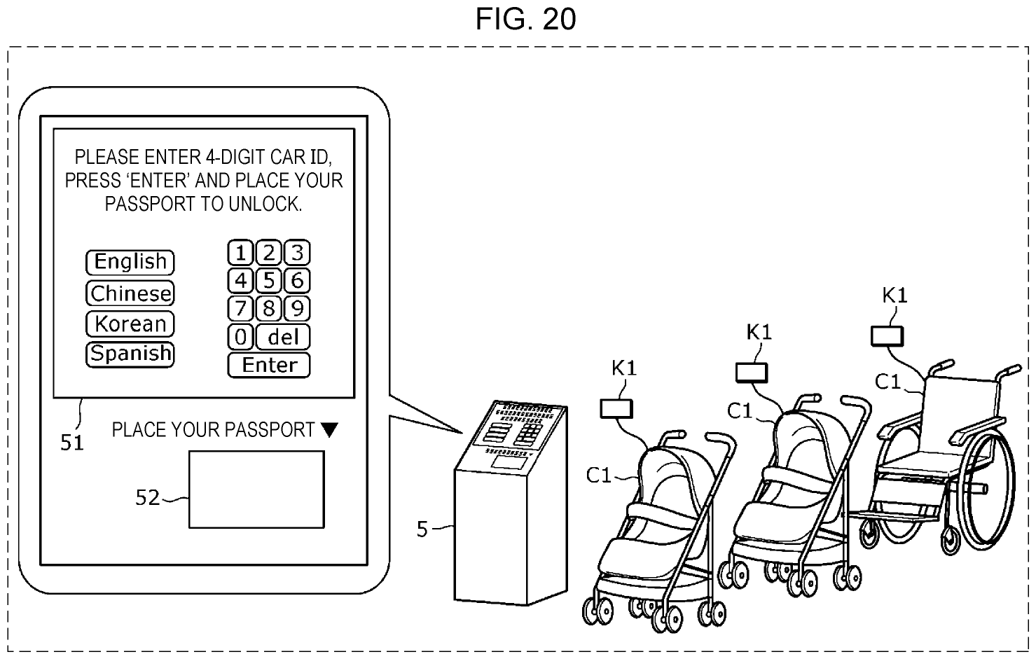

FIG. 20 is a schematic view illustrating an example of a rental area for renting the vehicle C1 according to Embodiment 4. In the example illustrated in FIG. 20, a single wheelchair as the vehicle C1 and two strollers as the vehicle C1 are locked by a chain equipped with a key K1 in the rental area. The user B1 can unlock the key K1 of the vehicle C1 which the user B1 wants to use by operating an operation terminal 5 placed at the rental area. Specifically, for example, the user B1 can unlock the key K1 of the vehicle C1 by entering a four-digit vehicle ID that is an identification number of the vehicle C1 on a touch panel 51 of the operation terminal 5 and making a passport reader 52 read a passport of the user B1. In this way, the user B1 can unlock the key K1, bring the vehicle C1 out of the rental area, and temporarily use the vehicle C1.

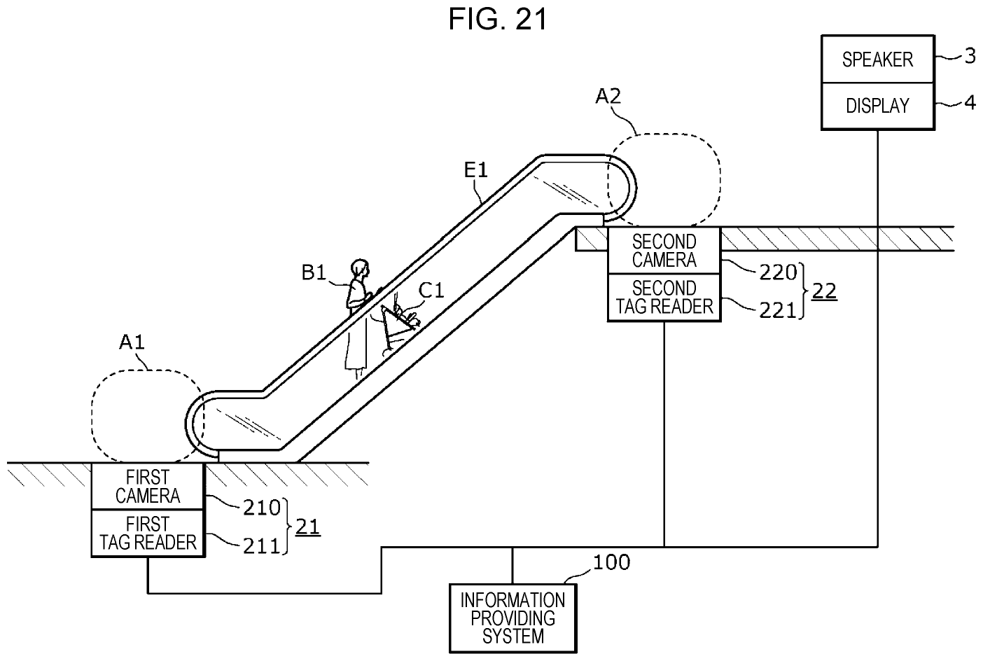

FIG. 21 is a schematic view illustrating an example of an environment in which the information providing system 100 according to Embodiment 4 is used. In Embodiment 4, a first tag reader 211 whose detection range is a first area A1 of the escalator E1 is further provided as a first sensor 21. A second tag reader 221 whose detection range is a second area A2 of the escalator E1 is further provided as a second sensor 22. The first tag reader 211 and the second tag reader 221 read information stored in an IC tag T1 attached to the vehicle C1 by wirelessly communicating with the IC tag T1.

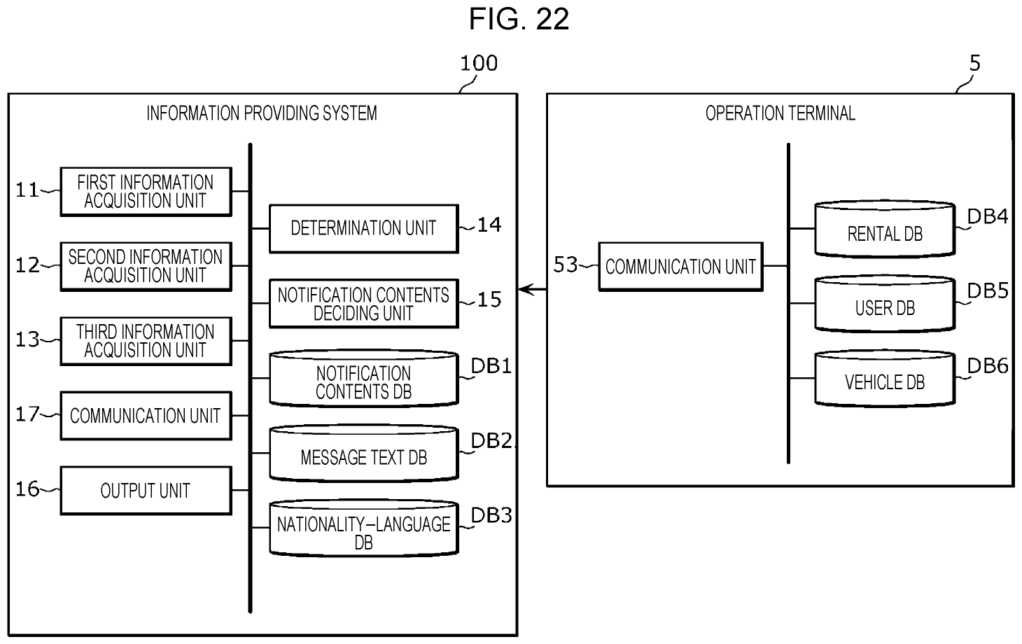

FIG. 22 is a block diagram illustrating an example of functional configurations of the information providing system 100 and the operation terminal 5 according to Embodiment 4. In Embodiment 4, the information providing system 100 further includes a communication unit 17 that performs wired communication or wireless communication with a communication unit 53 of the operation terminal 5. The information providing system 100 further has a message text database DB2 and a nationality-language database DB3 in addition to the notification contents database DB1. The operation terminal 5 has the communication unit 53, a rental database DB4, a user database DB5, and a vehicle database DB6.

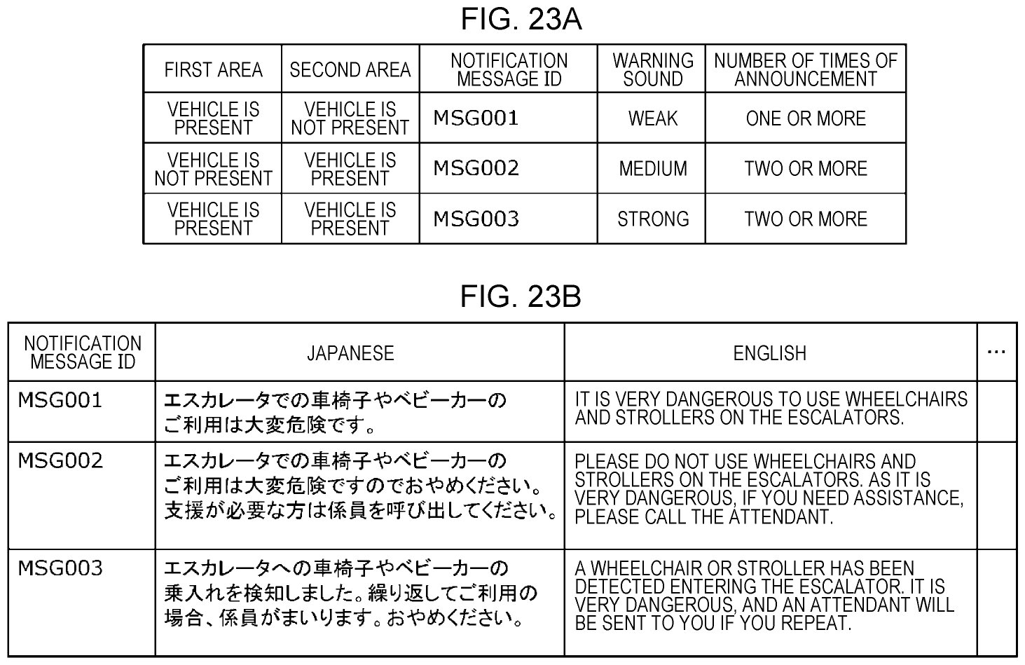

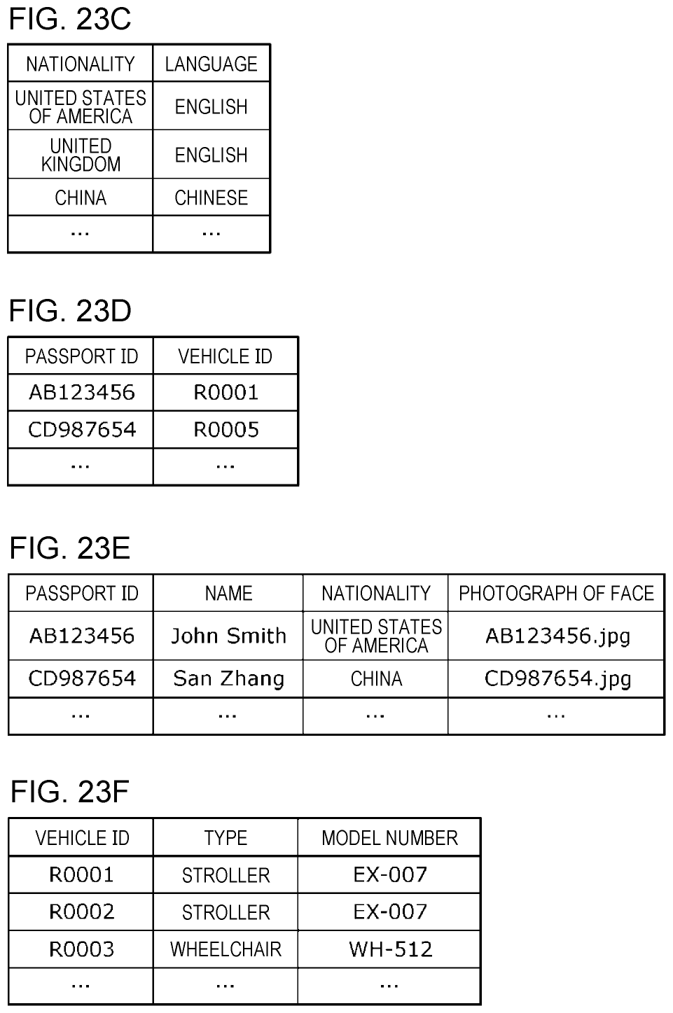

FIG. 23A illustrates an example of the notification contents database DB1 according to Embodiment 4. In Embodiment 4, a notification message ID is stored instead of a notification message in the notification contents database DB1, unlike the notification contents database DB1 illustrated in FIG. 6 of Embodiment 1. A notification contents deciding unit 15 acquires the notification message ID by comparing a result of determination performed by a determination unit 14 with the notification contents database DB1.

FIG. 23B illustrates an example of the message text database DB2 according to Embodiment 4. In the message text database DB2, messages of the same contents written in various languages are stored in association with a notification message ID. The notification contents deciding unit 15 decides a message text expressed in a language included in language information by comparing the notification message ID and the language information with the message text database DB2.

FIG. 23C illustrates an example of the nationality-language database DB3 according to Embodiment 4. In the nationality-language database DB3, nationality and language information concerning a language which a person of the nationality can understand are stored in association with each other.

FIG. 23D illustrates an example of the rental database DB4 according to Embodiment 4. In the rental database DB4, a passport ID given to a passport of the user B1 and a vehicle ID given to the rented vehicle C1 are stored in association with each other. That is, rental registration information is stored in the rental database DB4.

FIG. 23E illustrates an example of the user database DB5 according to Embodiment 4. In the user database DB5, information read from a passport by the passport reader 52 of the operation terminal 5, that is, a passport ID, a name of the user B1, nationality of the user B1, and a file of a photograph of a face of the user B1 are stored in association with each other. That is, passport information is stored in the user database DB5.

FIG. 23F illustrates an example of the vehicle database DB6 according to Embodiment 4. In the vehicle database DB6, a vehicle ID, a type of vehicle C1, and a model number of the vehicle C1 are stored in association with each other.

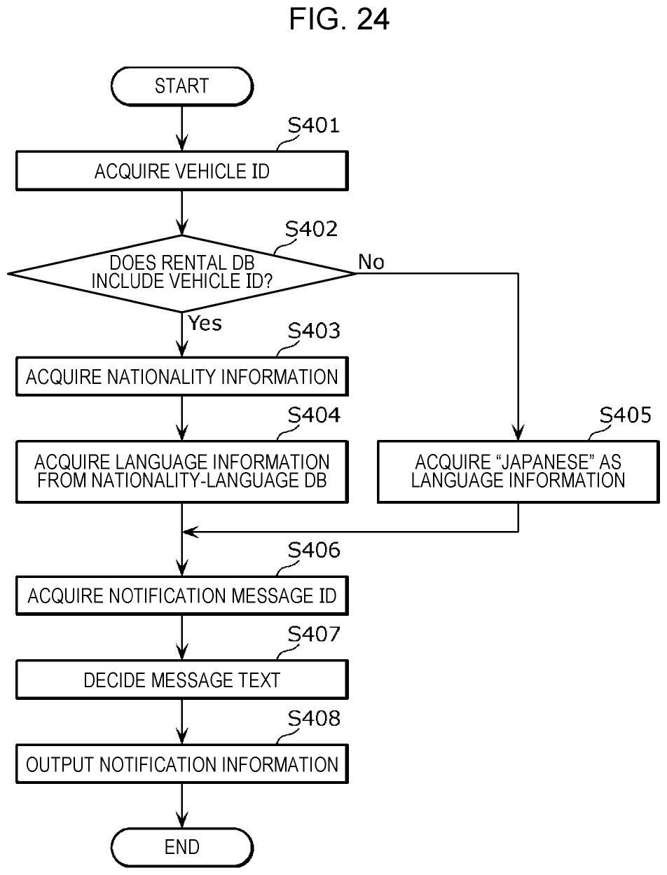

An example of operation of the information providing system 100 according to Embodiment 4 is described with reference to FIG. 24. FIG. 24 is a flowchart illustrating an example of processing of the information providing system 100 according to Embodiment 4.

First, the computer (the information providing system 100) acquires a vehicle ID by communicating with the IC tag T1 given to the vehicle C1 used by the user B1 by a tag reader (the first tag reader 211 or the second tag reader 221) (step S401).

Next, the notification contents deciding unit 15 conducts a search as to whether or not the acquired vehicle ID is included in the rental database DB4 by comparing the vehicle ID with the rental database DB4 (step S402). In a case where the vehicle ID is included in the rental database DB4 (step S402: Yes), the notification contents deciding unit 15 acquires a passport ID corresponding to the vehicle ID, and acquires nationality information concerning nationality of the user B1 by comparing the acquired passport ID with the user database DB5 (step S403).

Next, the notification contents deciding unit 15 acquires language information concerning a language which the user B1 can understand by comparing the acquired nationality information with the nationality-language database DB3 (step S404). Note that in a case where the vehicle ID is not included in the rental database DB4 (step S402: No), the notification contents deciding unit 15 acquires language information “Japanese” (step S405).

Next, the notification contents deciding unit 15 acquires a notification message ID by comparing a result of determination performed by the determination unit 14 with the notification contents database DB1 (step S406). Then, the notification contents deciding unit 15 decides a message text expressed in a language included in the language information by comparing the acquired notification message ID and language information with the message text database DB2 (S407).

Then, the output unit 16 outputs notification information indicative of the notification contents decided by the notification contents deciding unit 15 (step S303). In this example, the output unit 16 outputs the notification information by outputting a message text of the contents decided by the notification contents deciding unit 15 as voice from the speaker 3 together with warning sound and displaying the message text on the display 4.

As described above, in Embodiment 4, since a notification according to a language which the user B1 can understand is given, the user B1 is more likely to notice an alert, and an effect of the alert can be further increased.

Note that although an example in which the rental database DB4 is included in the operation terminal 5 in the rental area has been described in Embodiment 4, this is not restrictive. For example, in a case where the operation terminal 5 has a function of writing information into the IC tag T1, a vehicle ID and nationality information concerning nationality of the user B1 may be recorded in the IC tag T1 given to the vehicle C1 to be rented on the basis of passport information read by the passport reader 52. In this case, the information providing system 100 may directly acquire the nationality information of the user B1 from the IC tag T1 by communicating with the IC tag T1 by a tag reader (the first tag reader 211 or the second tag reader 221).

Although a flow of acquiring a vehicle ID from the IC tag T1 and acquiring nationality information by using the vehicle ID has been described in Embodiment 4, this is not restrictive. For example, the notification contents deciding unit 15 may acquire the nationality information of the user B1 by comparing a face image of the user B1 included in first information or second information with a photograph of a face of the user B1 registered in the user database DB5 and thereby identifying the user B1.

In Embodiment 4, a type or a model number of the vehicle C1 may be reflected in a message text. For example, a message text “IT IS VERY DANGEROUS TO USE STROLLERS ON THE ESCALATORS.” may be used by using the type (e.g., a stroller) of vehicle C1 specified by comparing the acquired vehicle ID with the vehicle database DB6 instead of a message text “IT IS VERY DANGEROUS TO USE WHEELCHAIRS AND STROLLERS ON THE ESCALATORS.” in the message text database DB2.

Furthermore, although an example in which nationality information acquired from a passport is registered in the rental database DB4 and a message text expressed in a language which the user B1 can understand is decided by using the nationality information has been described in Embodiment 4, this is not restrictive. For example, nationality of the user B1 may be estimated by performing appropriate image analysis processing on an external appearance image of the user B1 taken by the first camera 210 or the second camera 220, and a language which the user B1 can understand may be estimated from the estimated nationality. Alternatively, an utterance of the user B1 may be recorded by a microphone installed at the escalator E1, and a language which the user B1 can understand may be estimated from the recorded data.

Although an example in which a single rental area for renting the vehicle C1 is provided and the rental database DB4, the user database DB5, and the vehicle database DB6 are included in the operation terminal 5 in the rental area has been described in Embodiment 4, rental areas and operation terminals 5 may be provided. In this case, the three databases may be included in a computer that is provided separately from the operation terminals 5 and controls the operation terminals 5.

### Embodiment 5

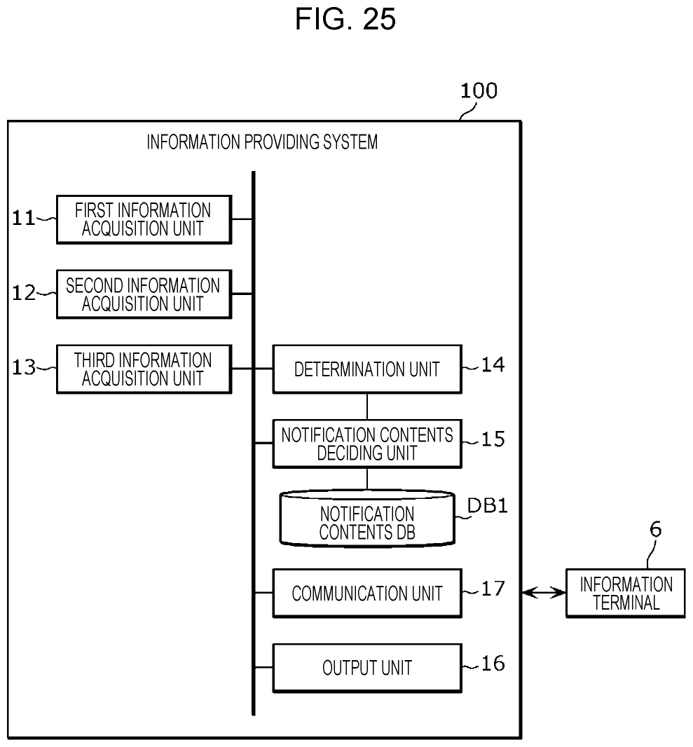

As illustrated in FIG. 25, an information providing system 100 according to Embodiment 5 is different from the information providing system 100 according to Embodiment 1 in that the information providing system 100 according to Embodiment 5 further includes a communication unit 17 that wirelessly communicates with an information terminal 6 possessed by a user B1 or a person relevant to the user B1. FIG. 25 is a block diagram illustrating an example of functional configurations of the information providing system 100 and the information terminal 6 according to Embodiment 5. The information terminal 6 is, for example, a mobile terminal such as a smartphone or a tablet terminal.

The communication unit 17 causes a notification signal including notification information indicative of notification contents decided by a notification contents deciding unit 15 to be broadcast from a communication device disposed close to a second area A2 of an escalator E1, for example, by near-field wireless communication compliant with a communication standard such as Bluetooth (Registered Trademark). In a case where the user B1 or a person relevant to the user B1 is present close to the second area A2, the information terminal 6 receives the notification signal from the communication device. That is, in Embodiment 5, the computer (the communication unit 17) transmits notification information to the information terminal 6 which the user (person) B1 or a person relevant to the user B1 possesses.

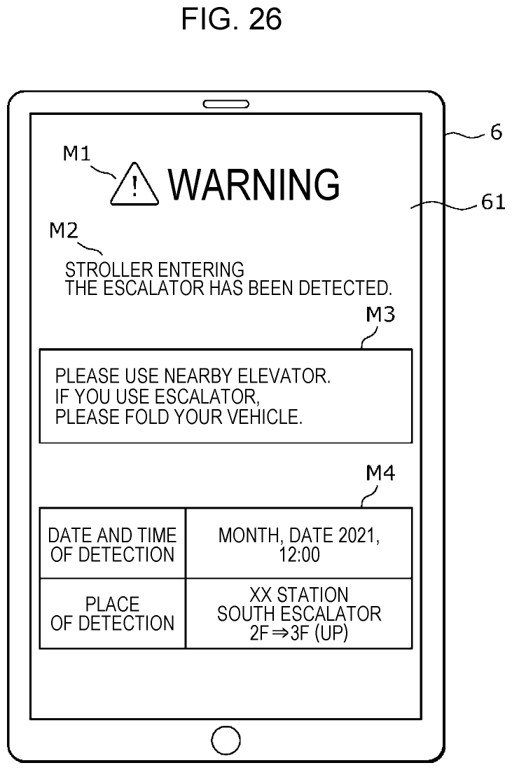

The information terminal 6 that has received the notification signal causes notification contents indicated by notification information included in the notification signal to be displayed on a display 61. The information terminal 6 may not only display the notification contents on the display 61, but also output warning sound from a speaker included in the information terminal 6. FIG. 26 illustrates an example of what is displayed on the information terminal 6 according to Embodiment 5. In the example illustrated in FIG. 26, a message M1 indicative of issuance of a warning, a message M2 indicating that entry of a vehicle C1 (in this example, a stroller) onto the escalator E1 has been detected, a message M3 for alerting the user B1, and a message M4 indicative of date and time of detection and a place of detection are displayed on the display 61 of the information terminal 6.

As described above, in Embodiment 5, since a notification is given by the information terminal 6 which the user B1 or a person relevant to the user B1 possesses, the user B1 is more likely to notice an alert, and an effect of the alert can be further increased. Note that the user B1 or a person relevant to the user B1 and the information terminal 6 which the user B1 or the person relevant to the user B1 possesses may be specified by performing appropriate image analysis processing on an image of the user B1 or the person relevant to the user B1 taken by a first camera 210 or a second camera 220. In this case, the communication unit 17 may transmit a notification signal to the specified information terminal 6.

### Embodiment 6

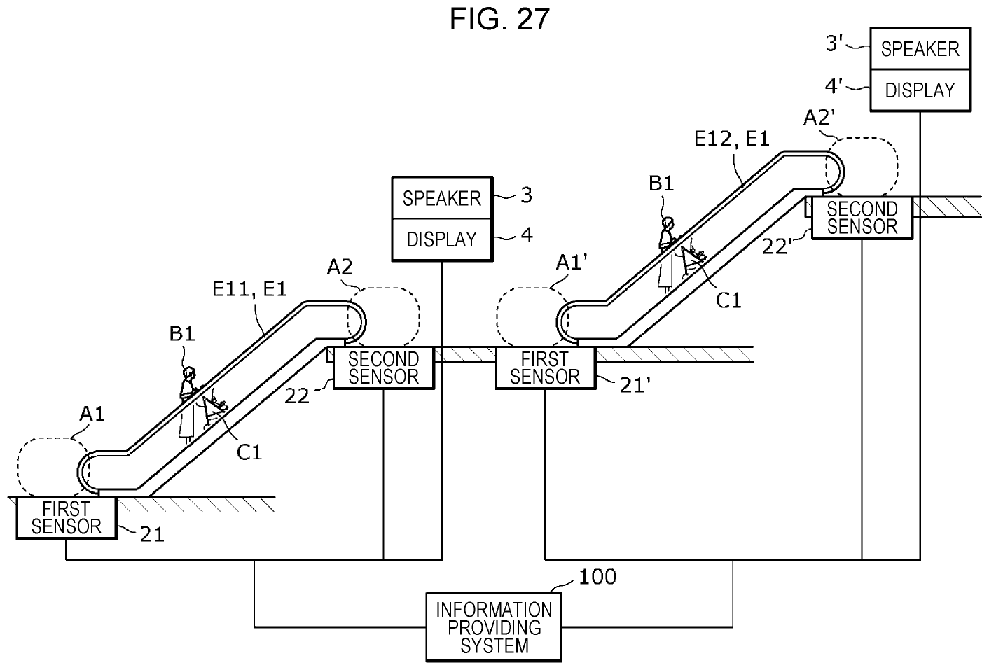

An information providing system 100 according to Embodiment 6 is different from the information providing system 100 according to Embodiment 1 in that there are two target escalators E1 as illustrated in FIG. 27. FIG. 27 illustrates an example of an environment in which the information providing system 100 according to Embodiment 6 is used. As illustrated in FIG. 27, both of the two escalators E1 are up escalators, and a second area A2 of one first escalator E11 and a first area A1 of the other second escalator E12 are located on same floor.

As in Embodiment 1, a first sensor 21, a second sensor 22, a speaker 3, and a display 4 are provided for the first escalator E11. A first sensor 21′, a second sensor 22′, a speaker 3′, and a display 4′ are provided for the second escalator E12. Note that the first sensor 21′, the second sensor 22′, the speaker 3′, and the display 4′ have identical configurations to the first sensor 21, the second sensor 22, the speaker 3, and the display 4, respectively.

That is, in Embodiment 6, the escalator E1 includes the first escalator E11 and the second escalator E12 that is successive to the first escalator E11 on a front side in a traveling direction of the user (person) B1. The computer (a notification contents deciding unit 15) decides notification contents at the second escalator E12 on the basis of notification contents decided for the first escalator E11.

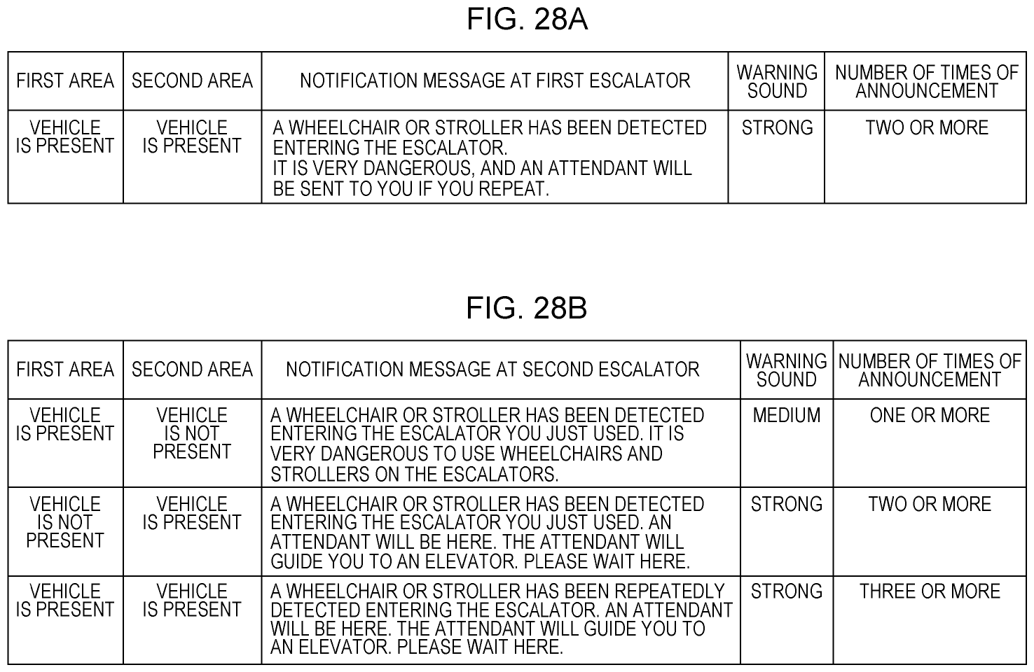

In Embodiment 6, as for the first escalator E11, the notification contents deciding unit 15 decides notification contents by comparing a result of determination performed by a determination unit 14 with a notification contents database DB1 for the first escalator E11 illustrated in FIG. 28A. As for the second escalator E12, the notification contents deciding unit 15 decides notification contents by comparing a result of determination performed by the determination unit 14 with a notification contents database DB1 illustrated in FIG. 28B.

FIG. 28A illustrates an example of a notification contents database for a first escalator according to Embodiment 6. In the example illustrated in FIG. 28A, data corresponding to a third determination result, which is a result of determination performed by the determination unit 14, is illustrated. FIG. 28B illustrates an example of a notification contents database for a second escalator according to Embodiment 6. In the example illustrated in FIG. 28B, data corresponding to first to third determination results, which are results of determination performed by the determination unit 14, are illustrated.

For example, in a case where the result of determination performed by the determination unit 14 at the first escalator E11 is the third determination result, the notification contents deciding unit 15 decides to output a notification message “A WHEELCHAIR OR STROLLER HAS BEEN DETECTED ENTERING THE ESCALATOR. IT IS VERY DANGEROUS, AND AN ATTENDANT WILL BE SENT TO YOU IF YOU REPEAT.”, issue warning sound of a large (strong) volume, and output the notification message two or more times, as illustrated in FIG. 28A. Then, the output unit 16 outputs notification information indicative of the notification contents by using the speaker 3 and the display 4, for example, at a timing when the user B1 reaches the second area A2 of the first escalator E11.

Then, in a case where a result of determination performed by the determination unit 14 at the second escalator E12 is any one of the first to third determination results, the notification contents deciding unit 15 decides to give a stronger alert than the alert given at the first escalator E11, as illustrated in FIG. 28B. Then, the output unit 16 outputs notification information indicative of the notification contents by using the speaker 3′ and the display 4′, for example, at a timing when the user B1 reaches the second area A2 of the second escalator E12.

As described above, in Embodiment 6, since a notification given at the escalator E1 which the user B1 uses later is decided on the basis of a notification given at the escalator E1 which the user B1 uses earlier, the user B1 is more likely to notice an alert, and an effect of the alert can be further increased.

Note that the information providing system 100 according to Embodiment 6 is also applicable to a case where three or more escalators E1 are successively provided. In this case, one of two successive escalators E1 among the escalators E1 is the first escalator E11, and the other one of the two successive escalators E1 is the second escalator E12.

### Embodiment 7

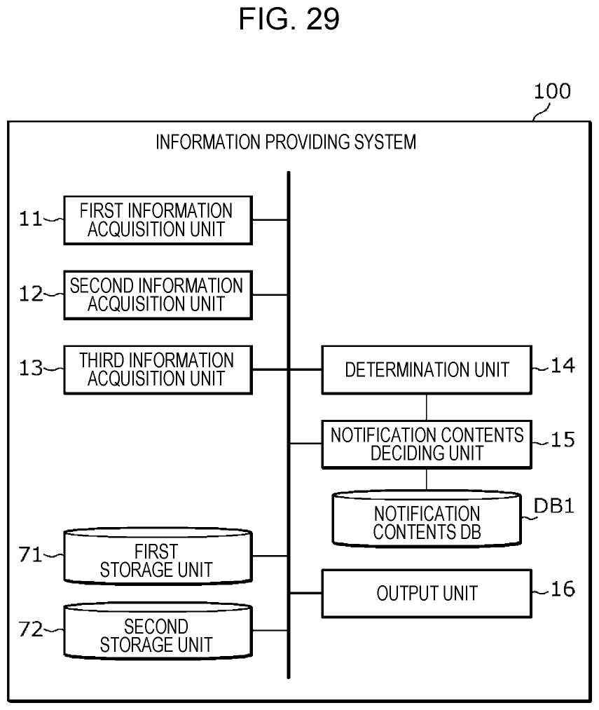

An information providing system 100 according to Embodiment 7 is different from the information providing system 100 according to Embodiment 1 in that the information providing system 100 according to Embodiment 7 collects learning data for improving accuracy of detection of a vehicle C1. FIG. 29 is a block diagram illustrating an example of a functional configuration of the information providing system 100 according to Embodiment 7. As illustrated in FIG. 29, the information providing system 100 according to Embodiment 7 includes a first storage unit 71 and a second storage unit 72.

The first storage unit 71 stores therein a result of detection (in this example, an image taken by a first camera 210) that is data obtained by a first sensor 21 in a case where the first sensor 21 fails to detect the vehicle C1. The data is given a ground truth label indicating the presence of the vehicle C1. The second storage unit 72 stores therein a result of detection (in this example, an image taken by a second camera 220) that is data obtained by the second sensor 22 in a case where the second sensor 22 fails to detect the vehicle C1. The data is given a ground truth label indicating the presence of the vehicle C1.

That is, the first storage unit 71 and the second storage unit 72 store therein, as learning data, data that should be a detection result indicating the presence of the vehicle C1 but is data indicating the absence of the vehicle C1 due to insufficient accuracy of image analysis processing performed by a trained model that has been trained by machine learning. The trained model is a model that has been trained by machine learning so as to output a result indicative of the presence or absence of the vehicle C1 in response to an input image.

Therefore, it can be expected that accuracy of the image analysis processing performed by the trained model is improved by re-training the trained model by using the learning data stored in the first storage unit 71 and the second storage unit 72.

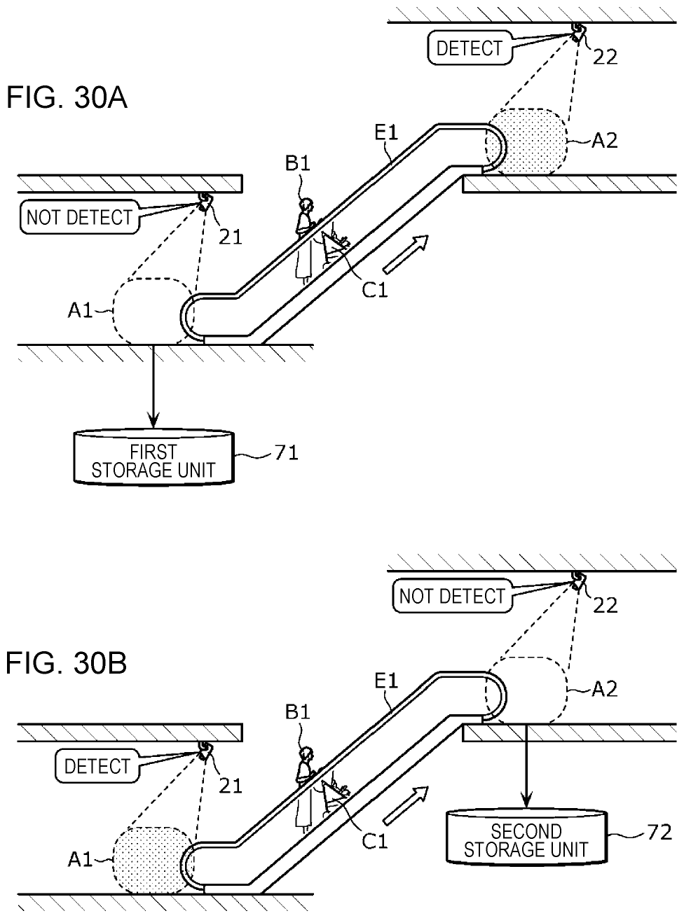

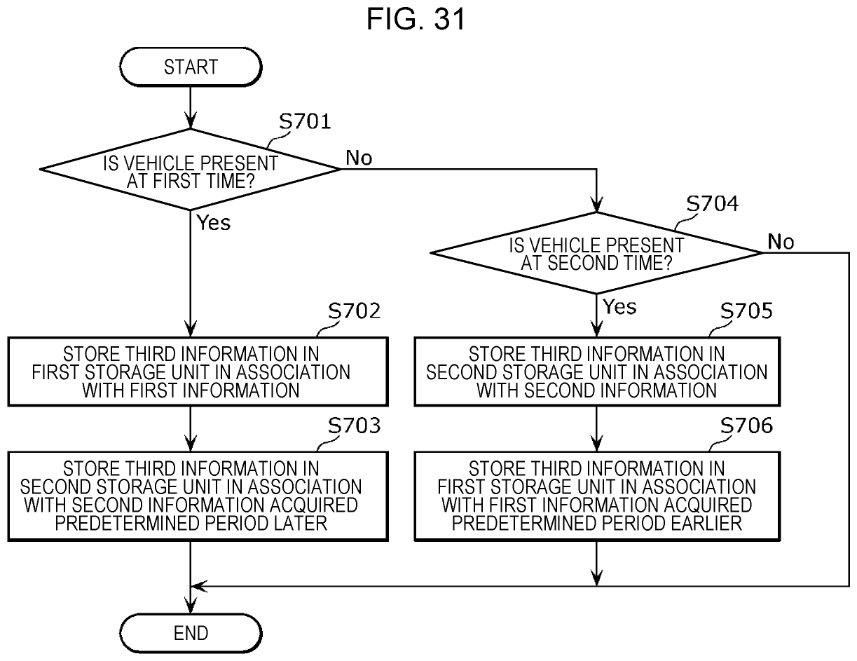

An example of operation of the information providing system 100 according to Embodiment 7 is described with reference to FIGS. 30A and 30B and 31. FIGS. 30A and 30B are schematic views illustrating an example of operation of the information providing system 100 according to Embodiment 7. FIG. 31 is a flowchart illustrating an example of processing of the information providing system 100 according to Embodiment 7. In the following description, it is assumed that data obtained in a case where the vehicle C1 has been detected is also stored in the first storage unit 71 and the second storage unit 72.

First, a case where the vehicle C1 is not detected at a first time when first information is acquired (step S701: No) and the vehicle C1 is detected at a second time when second information is acquired (step S704: Yes) as illustrated in FIGS. 30A and 31 is described. The first time is a time of detection of a user B1 in a first area A1 of an escalator E1. The second time is a time of detection of the user B1 in a second area A2 of the escalator E1.

In this case, the computer (the information providing system 100) causes third information indicative of the presence of the vehicle C1 to be stored in the second storage unit 72 in association with the second information (step S705). The computer (the information providing system 100) causes the first information acquired a predetermined period earlier than the second time to be stored in the first storage unit 71 in association with the third information indicative of the presence of the vehicle C1 (step S706).

In Embodiment 7, the predetermined period is decided on the basis of an operating speed of the escalator E1. For example, the predetermined period can be calculated by dividing a length of the escalator E1 in a traveling direction by the operating speed of the escalator E1.

Next, a case where the vehicle C1 is detected at the first time when the first information is acquired (step S701: Yes) and the vehicle C1 is not detected at the second time when the second information is acquired as illustrated in FIGS. 30B and 31 is described.

In this case, the computer (the information providing system 100) causes third information indicative of the presence of the vehicle C1 to be stored in the first storage unit 71 in association with the first information (step S702). The computer (the information providing system 100) causes the second information acquired a predetermined period later than the first time to be stored in the second storage unit 72 in association with the third information indicative of the presence of the vehicle C1 (step S703).

As described above, in Embodiment 7, in a case where third information indicative of the presence of the vehicle C1 is acquired at the first time when the first information is acquired, the computer (the information providing system 100) causes the first information to be stored in the first storage unit 71 in association with the third information and causes second information acquired a predetermined period later than the first time to be stored in the second storage unit 72 in association with the third information. In a case where third information indicative of the presence of the vehicle C1 is acquired at the second time when the second information is acquired, the computer (the information providing system 100) causes the second information to be stored in the second storage unit 72 in association with the third information and causes first information acquired a predetermined period earlier than the second time to be stored in the first storage unit 71 in association with the third information. Note that in a case where the user B1 can be distinguished, the computer (the information providing system 100) may cause second information acquired at a time when the user B1 detected at the first time is detected in the second area A2 to be stored in the second storage unit 72 in association with the third information. Similarly, the computer (the information providing system 100) may cause first information acquired at a time when the user B1 detected at the second time is detected in the first area A1 to be stored in the first storage unit 71 in association with the third information. In this case, calculation of the predetermined period is unnecessary.

Although first information (or second information) is stored in the first storage unit 71 (or the second storage unit 72) in association with the third information in Embodiment 7, this is not restrictive. For example, date and time of acquisition of the first information (or the second information), notification information that has been output, an identifier unique to the escalator E1, or the like may be stored in the first storage unit 71 (or the second storage unit 72) in association with the third information. Furthermore, this is not restrictive, the number of visitors to a whole building (e.g., shop) where the escalator E1 is installed, surrounding brightness of the escalator E1, weather including a season, event information, or the like may be stored in the first storage unit 71 (or the second storage unit 72) in association with the third information.

### Modifications

In each of the above embodiments, each constituent element may be realized by dedicated hardware or may be realized by executing a software program suitable for the constituent element. Each constituent element may be realized by reading out a software program recorded in a recording medium such as a hard disk or a semiconductor memory and executing the software program by a program executing unit such as a central processing unit (CPU) or a processor. A software program for realizing the information providing system (information providing method) or the like according to each of the above embodiments causes a computer to execute the steps in the flowchart illustrated in FIG. 7, 13, 17, 19, 24, or 31.

Note that the following cases are also encompassed within the present disclosure.

(1) At least one of the systems is specifically a computer system that includes a microprocessor, a ROM, a RAM, a hard disk unit, a display unit, a keyboard, a mouse, and the like. A computer program is stored in the RAM or the hard disk unit. The microprocessor operates in accordance with the computer program, and thus the at least one of the systems accomplishes a function thereof. The computer program is a combination of command codes indicating a command given to a computer for accomplishment of a predetermined function.

(2) Part of or all of constituent elements that constitute at least one of the systems may include a single system large scale integration (LSI). The system LSI is a super-multi-function LSI produced by integrating constituents on a single chip and is specifically a computer system including a microprocessor, a ROM, a RAM, and the like. A computer program is stored in the RAM. The microprocessor operates in accordance with the computer program, and thus the system LSI accomplishes a function thereof.

(3) Part of or all of constituent elements that constitute at least one of the systems may include an IC card that can be detachably attached to the apparatus or a stand-alone module. The IC card or the module is a computer system that includes a microprocessor, a ROM, a RAM, and the like. The IC card or the module may include the super-multi-function LSI. The microprocessor operates in accordance with a computer program, and thus the IC card or the module accomplishes a function thereof. The IC card or the module may have tamper resistance.

(4) The present disclosure may be the methods described above. The present disclosure may be a computer program for causing a computer to realize these methods or may be a digital signal represented by the computer program.

The present disclosure may be a computer-readable recording medium, such as a flexible disc, a hard disk, a compact disc (CD)-ROM, a DVD, a DVD-ROM, a DVD-RAM, a Blu-ray (Registered Trademark) Disc (BD), or a semiconductor memory, on which the computer program or the digital signal is recorded. The present disclosure may be the digital signal recorded on such a recording medium.

The present disclosure may be the computer program or the digital signal transmitted over an electric communication line, a wireless or wired communication line, a network represented by the Internet, data broadcasting, or the like.

The program or the digital signal may be executed by another independent computer system by transporting the program or the digital signal recorded on the recording medium or transporting the program or the digital signal over the network or the like.

### Other Remarks

A method according to an aspect of the present disclosure may be the following method.

A method executed by one or more computers, the method comprising
(a-1) acquiring a first image output by a first camera that images a first region,
(a-2) acquiring a second image output by a second camera that images a second region,
(a-3) deciding information a on the basis of the first image, the information a being information b indicating that the first region includes a first vehicle or information c indicating that the first region does not include the first vehicle,
(a-4) deciding information d on the basis of the second image, the information d being information e indicating that the second region includes a second vehicle or information f indicating that the second region does not include the second vehicle, and
(a-5) outputting a first notification including the information b and the information e, a second notification corresponding to the information b and the information f, or a third notification corresponding to the information c and the information e, wherein
a whole escalator or a part of the escalator is located between the first region and the second region, and
the first notification, the second notification, and the third notification are different from one another.

The description in (a-1) is, for example, based on the description of the first information acquisition unit 11. The first region is, for example, the first area A1, and the first camera is, for example, the first camera 210.

The description in (a-2) is, for example, based on the description of the second information acquisition unit 12. The second region is, for example, the second area A2, and the second camera is, for example, the second camera 220.

The description in (a-3) and (a-4) is, for example, based on the description of the third information acquisition unit 13.

The description in (a-5) is, for example, based on the description of S104, S105, S106, and FIG. 6.

The description “a whole escalator or a part of the escalator is located between the first region and the second region” is, for example, based on the description of FIGS. 5A to 5C.

The description “the first notification, the second notification, and the third notification are different from one another” is, for example, based on the description of FIG. 6.

A method according to an aspect of the present disclosure may be the following method.

A method executed by one or more computers, the method comprising
(a-1) acquiring a first image output by a first camera that images a first region,
(a-2) acquiring a second image output by a second camera that images a second region,
(a-3) deciding information a on the basis of the first image, the information a being information b indicating that a first vehicle included in the first region is folded or information c indicating that the first vehicle is not folded,
(a-4) deciding information d on the basis of the second image, the information d being information e indicating that a second vehicle included in the second region is folded or information f indicating that the second vehicle is not folded, and
(a-5) outputting a first notification corresponding to the information b and the information e, a second notification corresponding to the information b and the information f, a third notification corresponding to the information c and the information e, or a fourth notification corresponding to the information c and the information f, wherein
a whole escalator or a part of the escalator is located between the first region and the second region, and
the first notification, the second notification, the third notification, and the fourth notification are different from one another.

The description in (a-1) is, for example, based on the description of the first information acquisition unit 21. The first region is, for example, the first area A1, and the first camera is, for example, the first camera 210.

The description in (a-2) is, for example, based on the description of the second information acquisition unit 22. The second region is, for example, the second area A2, and the second camera is, for example, the second camera 220.

The description in (a-3) and (a-4) is, for example, based on the description of the third information acquisition unit 13.

The description in (a-5) is, for example, based on the description of S203, S204, S205, and FIG. 12.

The description “a whole escalator or a part of the escalator is located between the first region and the second region” is, for example, based on the description of FIGS. 11A to 11C.

The description “the first notification, the second notification, the third notification, and the fourth notification are different from one another” is, for example, based on the description of FIG. 12.

The information providing method, the information providing system, and the non-transitory computer-readable recording medium according to the present disclosure can be used to adjust a degree of an alert in accordance with a possibility of entry of a vehicle such as a stroller onto an escalator.

What is claimed is:

1. An information providing method comprising causing a computer to:
acquire first information concerning a person present in a first area of an escalator;
acquire second information concerning the person present in a second area of the escalator;
acquire third information concerning a vehicle present on the escalator that is relevant to at least one of the first information or the second information;
determine a change in state of the vehicle on a basis of the third information; and
output notification information indicative of notification contents decided on a basis of the determined change in state of the vehicle.

2. The information providing method according to claim 1, wherein
the state of the vehicle includes presence or absence of the vehicle.

3. The information providing method according to claim 1, wherein
the vehicle is at least one of a wagon, a cart, or a stroller.

4. The information providing method according to claim 1, wherein
the computer acquires the first information and the third information from an image taken by a first camera that images the first area and acquires the second information and the third information from an image taken by a second camera that images the second area.

5. The information providing method according to claim 1, wherein
the vehicle has an IC tag in which information concerning the state of the vehicle is recorded; and
the computer acquires the third information by reading the information from the IC tag by a tag reader.

6. The information providing method according to claim 1, wherein
the computer acquires the third information by detecting the first area from a first direction and acquires the third information by detecting the second area from a second direction; and
the first direction and the second direction are different.

7. The information providing method according to claim 1, wherein
the change in state of the vehicle includes a change in shape of the vehicle.

8. The information providing method according to claim 7, wherein
the change in shape of the vehicle is a change in shape caused by folding the vehicle.

9. The information providing method according to claim 7, wherein
the third information includes fourth information indicative of a shape of the vehicle at a time of acquisition of the first information and fifth information indicative of a shape of the vehicle at a time of acquisition of the second information; and
the computer specifies the change in shape of the vehicle on a basis of the fourth information and the fifth information.

10. The information providing method according to claim 1, further comprising causing the computer to acquire feature information indicative of a feature of at least one of the person or the vehicle,
wherein the notification contents are decided on a basis of the feature information.

11. The information providing method according to claim 10, wherein
the feature information includes at least one of information concerning clothes of the person or information concerning a type of the vehicle.

12. The information providing method according to claim 10, wherein
the feature information includes language information concerning a language which the person can understand; and
the notification contents are decided on a basis of the language information.

13. The information providing method according to claim 10, wherein
the feature information includes relevant person information concerning a relevant person relevant to the person; and
the notification contents are decided on a basis of the relevant person information.

14. The information providing method according to claim 10, wherein
the feature information further includes state information indicative of a state of the person; and
the notification information is output from at least one of a speaker or a display on a basis of the state information.

15. The information providing method according to claim 14, wherein
the state information includes at least one of information indicative of an awake state or an asleep state of a person on the vehicle or information indicative of a state concerning sight or hearing of the person.

16. The information providing method according to claim 10, wherein
the vehicle is a rental vehicle;
the feature information includes an identifier of the rental vehicle; and
the notification contents are decided on a basis of user information concerning the person who has rented the rental vehicle corresponding to the identifier of the rental vehicle.

17. The information providing method according to claim 16, wherein
the user information includes at least one of passport information concerning the person including nationality or rental registration information concerning the person registered when the rental vehicle is rented.

18. The information providing method according to claim 1, wherein
the computer transmits the notification information to an information terminal which the person or a person relevant to the person possesses.

19. The information providing method according to claim 1, wherein
the escalator includes a first escalator and a second escalator that is successive to the first escalator on a front side in a traveling direction of the person; and
the computer decides the notification contents for the second escalator on a basis of the notification contents decided for the first escalator.

20. The information providing method according to claim 1, further comprising causing the computer to:
in a case where the third information indicative of presence of the vehicle is acquired at a first time of acquisition of the first information, store the first information in a first storage in association with the third information and store the second information acquired a predetermined period later than the first time in a second storage in association with the third information; and
in a case where the third information indicative of presence of the vehicle is acquired at a second time of acquisition of the second information, store the second information in the second storage in association with the third information and store the first information acquired a predetermined period earlier than the second time in the first storage in association with the third information.

21. The information providing method according to claim 20, wherein
the predetermined period is decided on a basis of an operating speed of the escalator.

22. An information providing system comprising:
a first information acquirer that acquires first information concerning a person present in a first area of an escalator;
a second information acquirer that acquires second information concerning the person present in a second area of the escalator;
a third information acquirer that acquires third information concerning a vehicle present on the escalator that is relevant to at least one of the first information or the second information;
a determiner that determines a change in state of the vehicle on a basis of the third information;
a notification contents decider that decides notification contents on a basis of the determined change in state of the vehicle; and
an output unit that outputs notification information indicative of the decided notification contents.

23. A non-transitory computer-readable recording medium storing a program causing a computer to:
acquire first information concerning a person present in a first area of an escalator;
acquire second information concerning the person present in a second area of the escalator;
acquire third information concerning a vehicle present on the escalator that is relevant to at least one of the first information or the second information;
determine a change in state of the vehicle on a basis of the third information; and
output notification information indicative of notification contents decided on a basis of the determined change in state of the vehicle.
